(19) United States
(12) Patent Application Publication
(10) Pub. No.: US 2016/0173960 A1
(43) Pub. Date: Jun. 16, 2016

(54) METHODS AND SYSTEMS FOR GENERATING AUDIOVISUAL MEDIA ITEMS

(71) Applicant: EYEGROOVE, INC., San Francisco, CA (US)

(72) Inventors: Scott Snibbe, San Francisco, CA (US); Graham McDermott, Berkeley, CA (US); Emile Baizel, San Francisco, CA (US); James Pollack, San Francisco, CA (US); Justin Ponczec, San Francisco, CA (US); Spencer Schoeben, Palo Alto, CA (US); Jesse Fulton, San Francisco, CA (US)

(21) Appl. No.: 15/051,618

(22) Filed: Feb. 23, 2016

Related U.S. Application Data
(63) Continuation-in-part of application No. 14/608,097, filed on Jan. 28, 2015, now Pat. No. 9,268,787.
(60) Provisional application No. 61/934,681, filed on Jan. 31, 2014.

(51) Int. Cl. H04N 21/854; H04N 21/2743; H04N 21/233; H04N 21/235; H04N 21/242; H04N 21/218; G11B 27/031; H04N 21/2343

(52) U.S. Cl. CPC H04N 21/854; G11B 27/031; H04N 21/2743; H04N 21/2343; H04N 21/2353; H04N 21/242; H04N 21/2181; H04N 21/233

(57) ABSTRACT

The various embodiments described herein include methods and systems for generating an audiovisual media item. In one aspect, a method is performed at a server system. The method includes: (1) receiving, from a first electronic device associated with a first user, a creation request to create the media item, the creation request including information identifying one or more audio files and one or more visual media files; (2) obtaining the visual media files; (3) requesting at least one audio file from a server in accordance with the information identifying the audio files; (4) in response to the request, receiving at least one audio file from the server; (5) obtaining any remaining audio files; (6) in response to receiving the creation request, generating the audiovisual media item based on the audio files and the visual media files; and (7) storing the generated audiovisual media item in a media item database.

### PRIORITY CLAIM AND RELATED APPLICATIONS

The present application is a continuation-in-part of U.S. application Ser. No. 14/608,097, entitled “Methods and Devices for Synchronizing and Sharing Media Items,” filed Jan. 28, 2015, which itself claims priority to U.S. Provisional Patent Application No. 61/934,681, filed Jan. 31, 2014, which are hereby incorporated by reference in their entirety.

This application is also related to U.S. patent application Ser. No. 14/608,099, entitled, “Methods and Devices for Touch-Based Media Creation,” filed Jan. 28, 2015, U.S. patent application Ser. No. 14/608,103, entitled, “Methods and Devices for Presenting Interactive Media Items,” filed Jan. 28, 2015, U.S. patent application Ser. No. 14/608,105, entitled, “Methods and Devices for Modifying Pre-Existing Media Items,” filed Jan. 28, 2015, and U.S. patent application Ser. No. 14/608,108, entitled, “Methods and Devices for Generating Media Items,” filed Jan. 28, 2015, which are hereby incorporated by reference in their entirety.

### TECHNICAL FIELD

This relates generally to the field of Internet technologies, including, but not limited to, generating audiovisual media items.

### BACKGROUND OF THE INVENTION

As wireless networks and the processing power of mobile devices have improved, web-based applications increasingly allow everyday users to create original content in real-time without professional software. For example, Instagram and Vine allow a user to create original media content that is personalized to the user's tastes—anytime and anywhere. Despite the advances in the provision of web-based media creation applications, some solutions for creating media content are clumsy or ill-suited to future improvements in provisioning media content.

### SUMMARY

Various implementations of systems, methods and devices within the scope of the appended claims each have several aspects, no single one of which is solely responsible for the attributes described herein. Without limiting the scope of the appended claims, after considering this disclosure, and particularly after considering the section entitled “Detailed Description” one will understand how the aspects of various implementations are used to present, modify, and manage media items.

In some embodiments, a client-side method of presenting a media item is performed at a client device (e.g., client device 104, FIGS. 1-2) with one or more processors and memory. The method includes detecting a user input to play the media item, where the media item is associated with at least a portion of an audio track and one or more media files. The method also includes: requesting the media item from a server in response to the user input; in response to the request, receiving, from the server, the one or more media files and information identifying at least the portion of the audio track; and obtaining at least the portion of the audio track based on the information identifying at least the portion of the audio track. The method further includes: displaying the one or more media files; and, while displaying the one or more media files, playing back at least the portion of the audio track in synchronization with the one or more media files.

In some embodiments, a client-side method of modifying a pre-existing media item is performed at a client device (e.g., client device 104, FIGS. 1-2) with one or more processors and memory. The method includes displaying a family tree associated with a root media item including a plurality of leaf nodes stemming from a genesis node, where: the genesis node corresponds to the root media item and a respective leaf node of the plurality of leaf nodes corresponds to a modified media item, where the modified media item is a modified version of the root media item; and the genesis node corresponding to the root media item and the respective leaf node corresponding to the first modified media item include metadata structures, where a respective metadata structure includes first information identifying one or more audio tracks, second information identifying one or more media files, and third information identifying zero or more audio and/or video effects. The method also includes: detecting a first user input selecting one of the nodes in the family tree; and, in response to detecting the first user input, displaying a user interface for editing a media item corresponding to the selected node. The method further includes: detecting one or more second user inputs modifying the media item corresponding to the selected node; and, in response to detecting the one or more second user inputs: modifying a metadata structure associated with the media item that corresponds to the selected node so as to generate modified metadata associated with a new media item; and transmitting, to a server, at least a portion of the modified metadata associated with the new media item.

In some embodiments, a server-side method of maintaining a database is performed at a server system (e.g., server system 108, FIGS. 1 and 3) with one or more processors and memory. The method includes: maintaining a database for a plurality of root media items, where: a respective root media item is associated with a family tree that includes a genesis node and a plurality of leaf nodes; the genesis node corresponds to the respective root media item and a respective leaf node of the plurality of leaf nodes corresponds to a first modified media item, the first modified media item is a modified version of the respective root media item; and the genesis node corresponding to the respective root media item and the respective leaf node corresponding to the first modified media item include metadata structures, where a respective metadata structure includes first information identifying one or more audio tracks, second information identifying one or more media files, and third information identifying zero or more audio and/or video effects. The method also includes receiving, from a client device, at least a portion of modified metadata corresponding to a second modified media item, where the second modified media item is a modified version of a media item corresponding to a respective node in the family tree. The method further includes appending, in response to receiving at least the portion of the modified metadata corresponding to the second modified media item, a new leaf node to the family tree that is linked to the respective node, where the new leaf node corresponds to the second modified media item.

In some embodiments, a server-side method of generating a media item is performed at a server system with one or more processors and memory. The method includes receiving a creation request from an electronic device associated with a user that includes information identifying one or more audio files and one or more visual media files; and obtaining the visual media files. The method also includes obtaining the one or more visual media files; requesting at least one audio file from a server in accordance with the information in the creation request identifying the one or more audio files; and, in response to the request, receiving the at least one audio file from the server. The method further includes obtaining and remaining audio files of the one or more audio files and, in response to receiving the creation request, generating the audiovisual media item based on the one or more audio files and the one or more visual media files; and storing the generated audiovisual media item in a media item database.

In some embodiments, a client-side method of sending a creation request is performed at a client device (e.g., client device 104, FIGS. 1-2) with one or more processors and memory. The method includes receiving one or more natural language inputs from a user and identifying one or more audio files by extracting one or more commands from the one or more natural language inputs. The method also includes receiving one or more second natural language inputs from a user and identifying one or more visual media files by extracting one or more commands from the one or more second natural language inputs. The method further includes obtaining a request to generate a media item corresponding to the one or more visual media files and the one or more audio files. The method also includes sending to a server system, in response to obtaining the request, a creation request to create the media item, the creation request including information identifying the one or more audio files and the one or more visual media files.

In some embodiments, an electronic device or a computer system (e.g., client device 104, FIGS. 1-2 or server system 108, FIGS. 1 and 3) includes one or more processors and memory storing one or more programs for execution by the one or more processors, the one or more programs include instructions for performing the operations of the methods described herein. In some embodiments, a non-transitory computer readable storage medium storing one or more programs, the one or more programs comprising instructions, which, when executed by an electronic device or a computer system (e.g., client device 104, FIGS. 1-2 or server system 108, FIGS. 1 and 3) with one or more processors, cause the electronic device or computer system to perform the operations of the methods described herein.

### BRIEF DESCRIPTION OF THE DRAWINGS

So that the present disclosure can be understood in greater detail, a more particular description may be had by reference to the features of various implementations, some of which are illustrated in the appended drawings. The appended drawings, however, merely illustrate the more pertinent features of the present disclosure and are therefore not to be considered limiting, for the description may admit to other effective features.

FIG. 1 is a block diagram of a server-client environment in accordance with some embodiments.

FIG. 2 is a block diagram of a client device in accordance with some embodiments.

FIG. 3 is a block diagram of a server system in accordance with some embodiments.

FIGS. 4A-4I illustrate example user interfaces for presenting and modifying a pre-existing media item in accordance with some embodiments.

FIG. 5A is a diagram of a media item metadata database in accordance with some embodiments.

FIG. 5B is a diagram of a representative metadata structure for a respective media item in accordance with some embodiments.

FIGS. 6A-6C illustrate a flowchart representation of a client-side method of presenting a media item in accordance with some embodiments.

FIGS. 7A-7B illustrate a flowchart representation of a client-side method of modifying a pre-existing media item in accordance with some embodiments.

FIGS. 8A-8B illustrate a flowchart representation of a server-side method of maintaining a database in accordance with some embodiments.

FIG. 9 is a schematic flow diagram of a method for generating audiovisual media items in accordance with some embodiments.

FIGS. 10A-10D illustrate a flowchart representation of a server-side method of generating audiovisual media items in accordance with some embodiments.

FIG. 11 is a schematic flow diagram representation of a method of sending a creation request to a server system in accordance with some embodiments.

FIGS. 12A-12C illustrate a flowchart representation of a client-side method of sending a creation request to a server system in accordance with some embodiments.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

Numerous details are described herein in order to provide a thorough understanding of the example implementations illustrated in the accompanying drawings. However, some embodiments may be practiced without many of the specific details, and the scope of the claims is only limited by those features and aspects specifically recited in the claims. Furthermore, well-known methods, components, and circuits have not been described in exhaustive detail so as not to unnecessarily obscure more pertinent aspects of the implementations described herein.

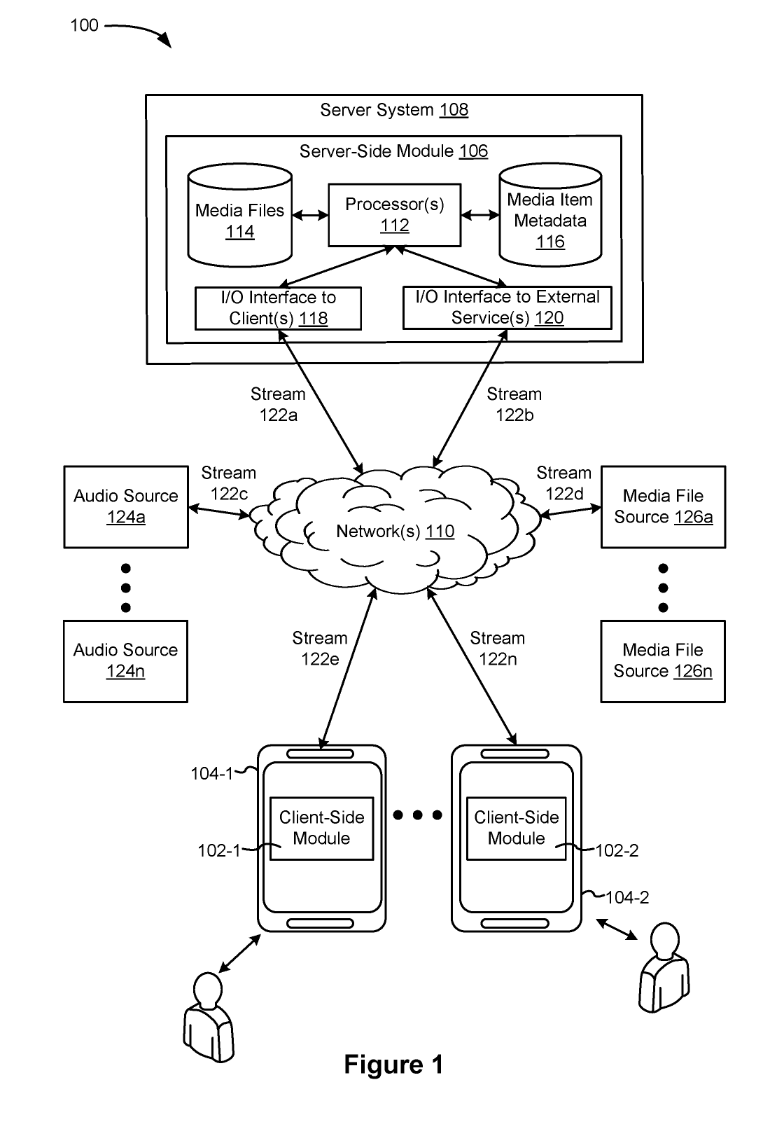

As shown in FIG. 1, an application for generating, exploring, and presenting media items is implemented in a server-client environment 100 in accordance with some embodiments. In some embodiments, the application includes client-side processing 102-1, 102-2 (hereinafter “client-side module 102”) executed on a client device 104-1, 104-2 and server-side processing 106 (hereinafter “server-side module 106”) executed on a server system 108. A client-side module 102 communicates with a server-side module 106 through one or more networks 110. A client-side module 102 provides client-side functionalities associated with the application (e.g., creation and presentation of media items) such as client-facing input and output processing and communications with a server-side module 106. A server-side module 106 provides server-side functionalities associated with the application (e.g., generating metadata structures for, storing portions of, and causing/directing presentation of media items) for any number of client modules 102 each residing on a respective client device 104.

In some embodiments, a server-side module 106 includes one or more processors 112, a media files database 114, a media item metadata database 116, an I/O interface to one or more clients 118, and an I/O interface to one or more external services 120. An I/O interface to one or more clients 118 facilitates the client-facing input and output processing for a server-side module 106. One or more processors 112 receive requests from a client-side module 102 to create media items or obtain media items for presentation. A media files database 114 stores media files, such as images and/or video clips, associated with media items, and a media item metadata database 116 stores a metadata structure for each media item, where each metadata structure associates one or more media files and at least a portion of an audio track with a media item. In some embodiments, a media files database 114 and a media item metadata database 116 are communicatively coupled with but located remotely from a server system 116. In some embodiments, a media files database 114 and a media item metadata database 116 are located separately from one another. In some embodiments, a server-side module 106 communicates with one or more external services such as audio sources 124a . . . 124n (e.g., streaming audio service providers such as Spotify, SoundCloud, Rdio, Pandora, and the like) and a media file sources 126a . . . 126n (e.g., service provider of images and/or video such as YouTube, Vimeo, Vine, Flickr, Imgur, and the like) through one or more networks 110. An I/O interface to one or more external services 120 facilitates such communications. In some embodiments the communications are streams 122a . . . 122n (e.g., multimedia bit streams, packet streams, integrated streams of multimedia information, data streams, natural language streams, compressed audio streams, and the like). Examples of a client device 104 include, but are not limited to, a handheld computer, a wearable computing device (e.g., Google Glass or a smart watch), a biologically implanted computing device, a personal digital assistant (PDA), a tablet computer, a laptop computer, a desktop computer, a cellular telephone, a smart phone, an enhanced general packet radio service (EGPRS) mobile phone, a media player, a navigation device, a game console, a television, a remote control, or a combination of any two or more of these data processing devices or other data processing devices.

Examples of one or more networks 110 include local area networks (“LAN”) and wide area networks (“WAN”) such as the Internet. One or more networks 110 are, optionally, implemented using any known network protocol, including various wired or wireless protocols, such as Ethernet, Universal Serial Bus (USB), FIREWIRE, Global System for Mobile Communications (GSM), Enhanced Data GSM Environment (EDGE), code division multiple access (CDMA), time division multiple access (TDMA), Bluetooth, Wi-Fi, voice over Internet Protocol (VoIP), Wi-MAX, or any other suitable communication protocol.

In some embodiments, a server system 108 is managed by the provider of the application for generating, exploring, and presenting media items. A server system 108 is implemented on one or more standalone data processing apparatuses or a distributed network of computers. In some embodiments, a server system 108 also employs various virtual devices and/or services of third party service providers (e.g., third-party cloud service providers) to provide the underlying computing resources and/or infrastructure resources of the server system 108.

Although a server-client environment 100 shown in FIG. 1 includes both a client-side portion (e.g., client-side module 102) and a server-side portion (e.g., server-side module 106), in some embodiments, the application is implemented as a standalone application installed on a client device 104. In addition, the division of functionalities between the client and server portions varies in different embodiments. For example, in some embodiments, a client-side module 102 is a thin-client that provides only user-facing input and output processing functions, and delegates all other data processing functionalities to a backend server (e.g., server system 108).

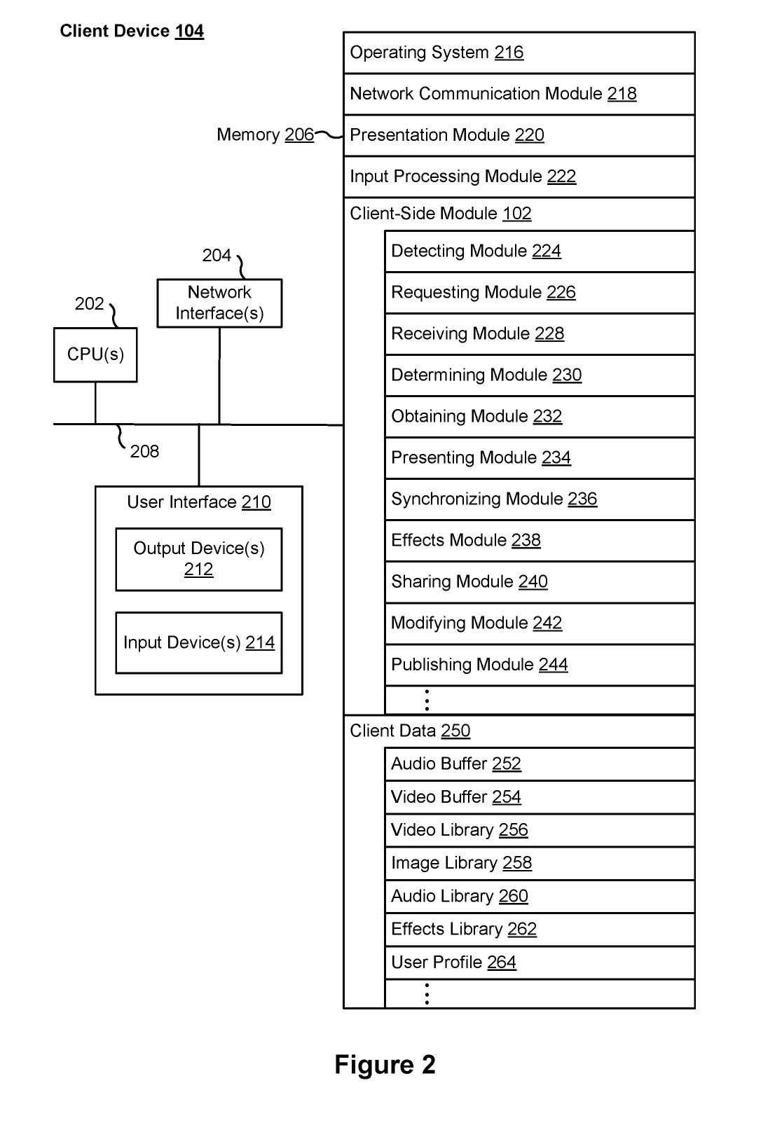

FIG. 2 is a block diagram illustrating a representative client device 104 associated with a user in accordance with some embodiments. A client device 104, typically, includes one or more processing units (CPUs) 202, one or more network interfaces 204, memory 206, and one or more communication buses 208 for interconnecting these components (sometimes called a chipset). A client device 104 also includes a user interface 210. A user interface 210 includes one or more output devices 212 that enable presentation of media content, including one or more speakers and/or one or more visual displays. A user interface 210 also includes one or more input devices 214, including user interface components that facilitate user input such as a keyboard, a mouse, a voice-command input unit or microphone, an accelerometer, a gyroscope, a touch-screen display, a touch-sensitive input pad, a gesture capturing camera, or other input buttons or controls. Furthermore, some client devices 104 use a microphone and voice recognition, a camera and gesture recognition, a brainwave sensor/display, or biologically implanted sensors/displays (e.g. digital contact lenses, fingertip/muscle implants, and so on) to supplement or replace the keyboard, display, or touch screen. The memory 206 includes high-speed random access memory, such as DRAM, SRAM, DDR RAM, or other random access solid state memory devices; and, optionally, includes non-volatile memory, such as one or more magnetic disk storage devices, optical disk storage devices, flash memory devices, or other non-volatile solid state storage devices. The memory 206, optionally, includes one or more storage devices remotely located from one or more processing units 202. the memory 206, or alternatively the non-volatile memory device(s) within the memory 206, includes a non-transitory computer readable storage medium. In some implementations, the memory 206, or the non-transitory computer readable storage medium of the memory 206, stores the following programs, modules, and data structures, or a subset or superset thereof:
an operating system 216 including procedures for handling various basic system services and for performing hardware dependent tasks;
a network communication module 218 for connecting a client device 104 to other computing devices (e.g., server system 108, audio sources 124a . . . 124n, and media file sources 126a . . . 126n) connected to one or more networks 110 via one or more network interfaces 204 (wired or wireless);
a presentation module 220 for enabling presentation of information (e.g., a media item, a user interface for an application or a webpage, audio and/or video content, text, etc.) at a client device 104 via one or more output devices 212 (e.g., displays, speakers, etc.) associated with a user interface 210; and
an input processing module 222 for detecting one or more user inputs or interactions from one of the one or more input devices 214 and interpreting the detected input or interaction.

In some embodiments, the memory 206 also includes a client-side module 102 associated with an application for creating, exploring, and playing back media items that includes, but is not limited to:
a detecting module 224 for detecting one or more user inputs corresponding to the application;
a requesting module 226 for querying a server (e.g., server system 108) for a media item;
a receiving module 228 for receiving, from a server system 108, one or more media files (e.g., one or more video clips and/or one or more images) and information identifying at least a portion of an audio track associated with the requested media item;
a determining module 230 for determining a source for the audio track associated with the media item;
an obtaining module 232 for obtaining at least the portion of the audio track associated with the audio track;
a presenting module 234 for presenting the requested media item via one or more output devices 212 by displaying the one or more media files associated with the media item on the display and playing back at least the portion of the audio track via the one or more speakers associated with the media item;
a synchronizing module 236 for synchronizing at least the portion of the audio track with the one or more media files;
an effects module 238 for applying audio and/or video effects while displaying the one or more media files and/or playing back at least the portion of the audio track;
a sharing module 240 for sharing the media item via one or more sharing methods (e.g., email, SMS, social media outlets, etc.);
a modifying module 242 for modifying a pre-existing media item so as to generate a new media item based on the pre-existing media item; and
a publishing module 244 for publishing the new media item.

In some embodiments, the memory 206 also includes client data 250 for storing data for the application. The client data 250 includes, but is not limited to:
an audio buffer 252 for buffering at least the portion of the obtained audio track for playback;
a video buffer 254 for buffering the one or more media files received from a server system 108 for display;
a video library 256 storing one or more pre-existing video clips recorded prior to executing the application;
an image library 258 storing one or more pre-existing images captured prior to executing the application;
an audio library 260 storing one or more pre-existing audio tracks created or stored prior to executing the application;
an effects library 262 including functions for implementing one or more real-time or post-processed audio and/or video effects (e.g., OpenGL Shading Language (GLSL) shaders); and
a user profile 264 including a plurality of preferences associated with the application for the user of a client device 104.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various implementations. In some implementations, the memory 206, optionally, stores a subset of the modules and data structures identified above. Furthermore, the memory 206, optionally, stores additional modules and data structures not described above.

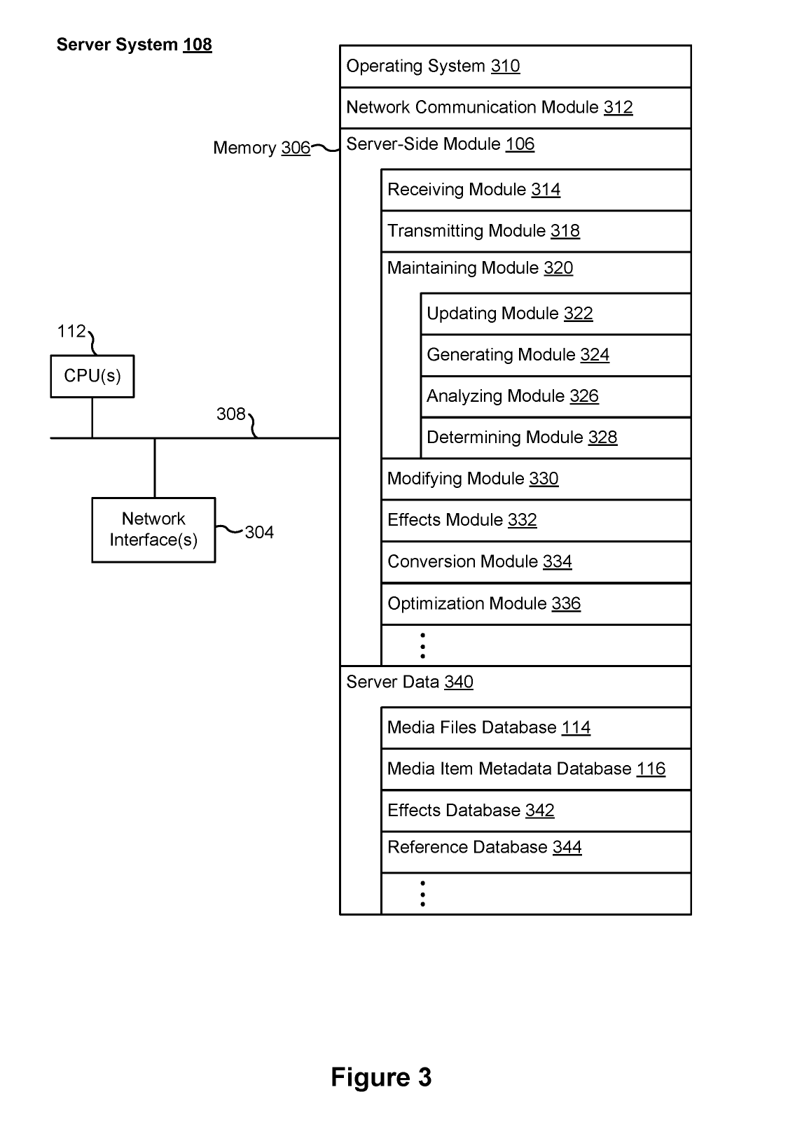

FIG. 3 is a block diagram illustrating a server system 108 in accordance with some embodiments. A server system 108, typically, includes one or more processing units (CPUs) 112, one or more network interfaces 304 (e.g., including I/O interface to one or more clients 118 and I/O interface to one or more external services 120), memory 306, and one or more communication buses 308 for interconnecting these components (sometimes called a chipset). The memory 306 includes high-speed random access memory, such as DRAM, SRAM, DDR RAM, or other random access solid state memory devices; and, optionally, includes non-volatile memory, such as one or more magnetic disk storage devices, optical disk storage devices, flash memory devices, or other non-volatile solid state storage devices. The memory 306, optionally, includes one or more storage devices remotely located from one or more processing units 112. The memory 306, or alternatively the non-volatile memory device(s) within memory 306, includes a non-transitory computer readable storage medium. In some implementations, the memory 306, or the non-transitory computer readable storage medium of the memory 306, stores the following programs, modules, and data structures, or a subset or superset thereof:
an operating system 310 including procedures for handling various basic system services and for performing hardware dependent tasks;
a network communication module 312 that is used for connecting a server system 108 to other computing devices (e.g., client devices 104, audio sources 124a . . . 124n, and media file sources 126a . . . 126n) connected to one or more networks 110 via one or more network interfaces 304 (wired or wireless);
a server-side module 106 associated with the application for generating, exploring, and presenting media items that includes, but is not limited to:
   a receiving module 314 for receiving a request, from a client device 104, to playback a media item or for receiving at least a portion of the modified metadata structure;
   a transmitting module 318 for transmitting, to a client device 104, one or more media files (e.g., one or more video clips and/or a sequence of one or more images) and information identifying at least a portion of an audio track associated with the requested media item; and
   a maintaining module 320 for maintaining a media item metadata database 116, including, but not limited to:
      an updating module 322 for updating one or more fields, tables, and/or entries in a metadata structure associated with a respective media item (e.g., play count, likes, shares, comments, associated media items, and so on);
      a generating module 324 for generating a metadata structure for a new media item and appending a new node associated with the new media item to a corresponding family tree;
      an analyzing module 326 for analyzing the audio track and the one or more media files associated with the new media item; and
      a determining module 328 determining whether the analyzed audio track and one or more media files match at least one of the reference audio tracks and video clips in a reference database 344;
   a modifying module 330 for flattening the new media item into a single stream or digital media item or for re-encoding media items for different formats and bit rates;
   an effects module 332 for receiving and transmitting at least one of the video and audio effects as scripts or computer-readable instructions (e.g., GLSL shaders for use with OpenGL ES) augmented with effect metadata corresponding to effect type, effect version, content, effect parameters, and so on;
server data 340, including but not limited to:
   a media files database 114 storing one or more media files (e.g., images and/or video clips);
   a media item metadata database 116 storing a metadata structure for each media item, where each metadata structure associates one or more media files and at least a portion of an audio track with a media item;
   an effects database 342 storing one or more real-time or post-processed audio and/or video effects as scripts or computer-readable instructions (e.g., GLSL shaders for use with OpenGL ES) augmented with effect metadata corresponding to effect type, effect version, content, effect parameters, a table mapping of interactive input modalities to effect parameters for real-time effect interactivity, and so on; and
   a reference database 344 storing a plurality of reference audio tracks and video clips and associated preferences.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, the memory 306, optionally, stores a subset of the modules and data structures identified above. Furthermore, the memory 306, optionally, stores additional modules and data structures not described above.

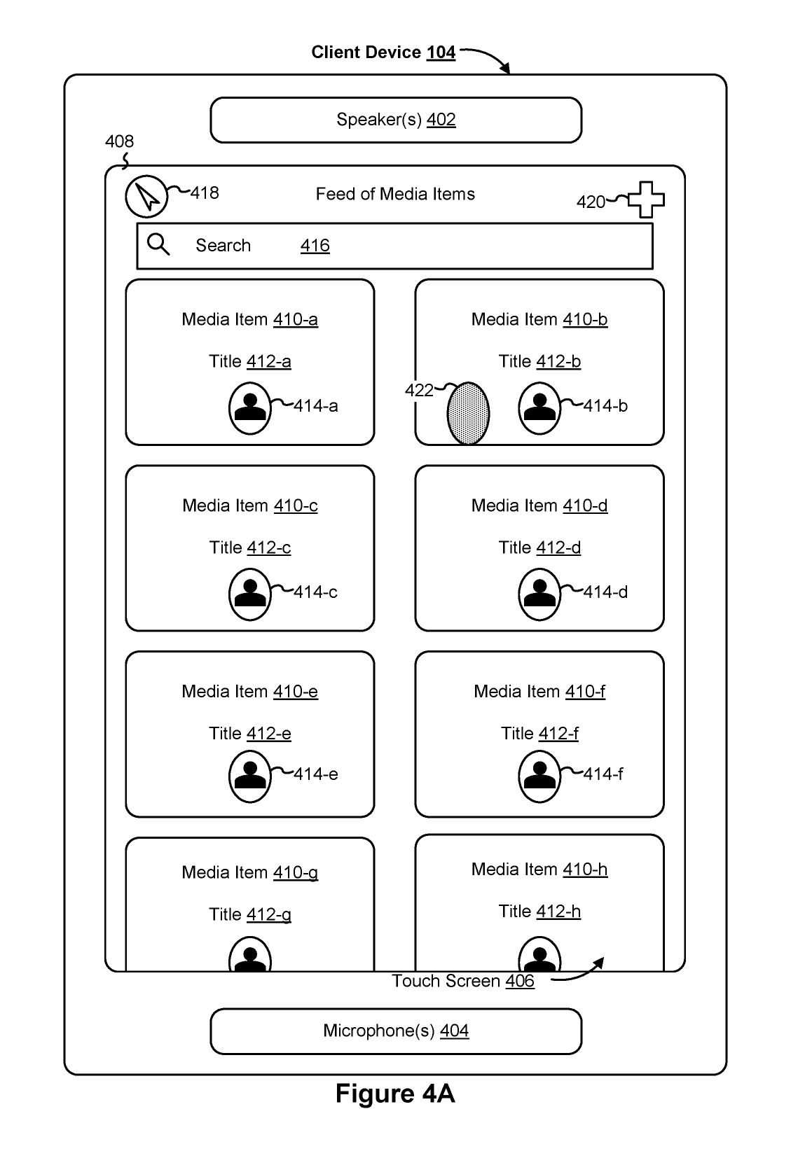

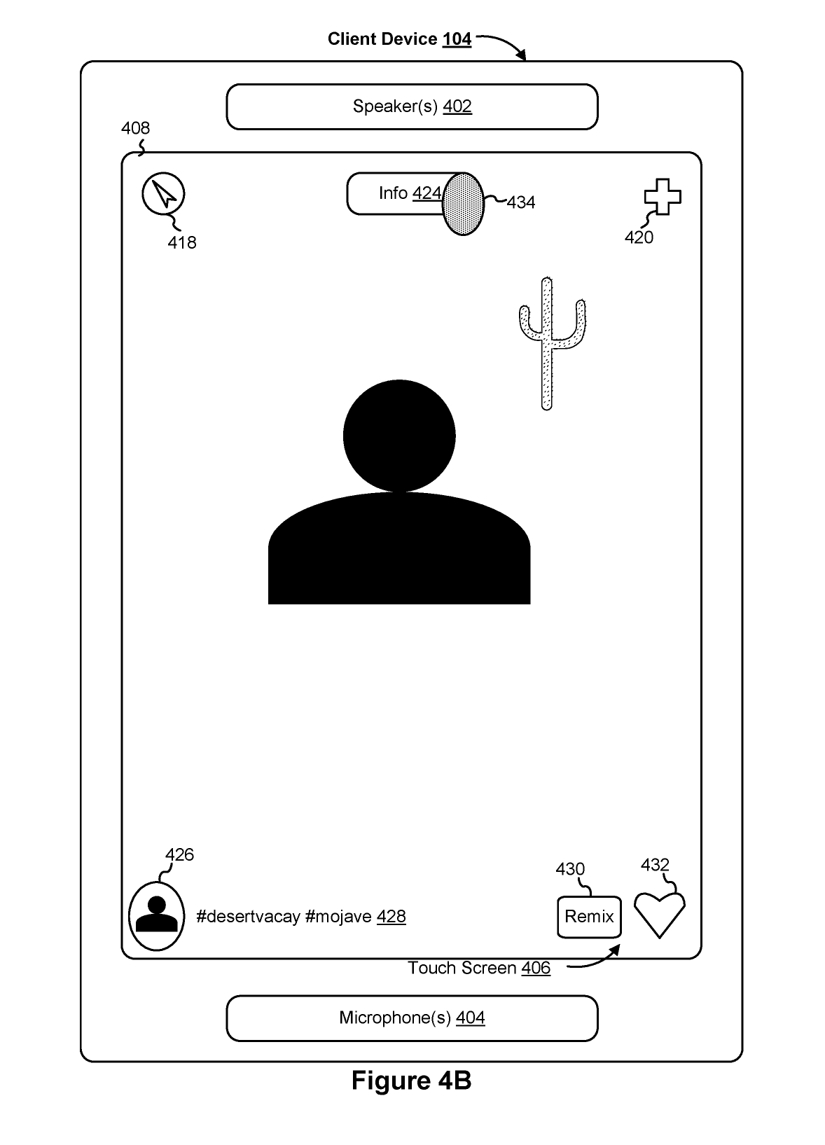

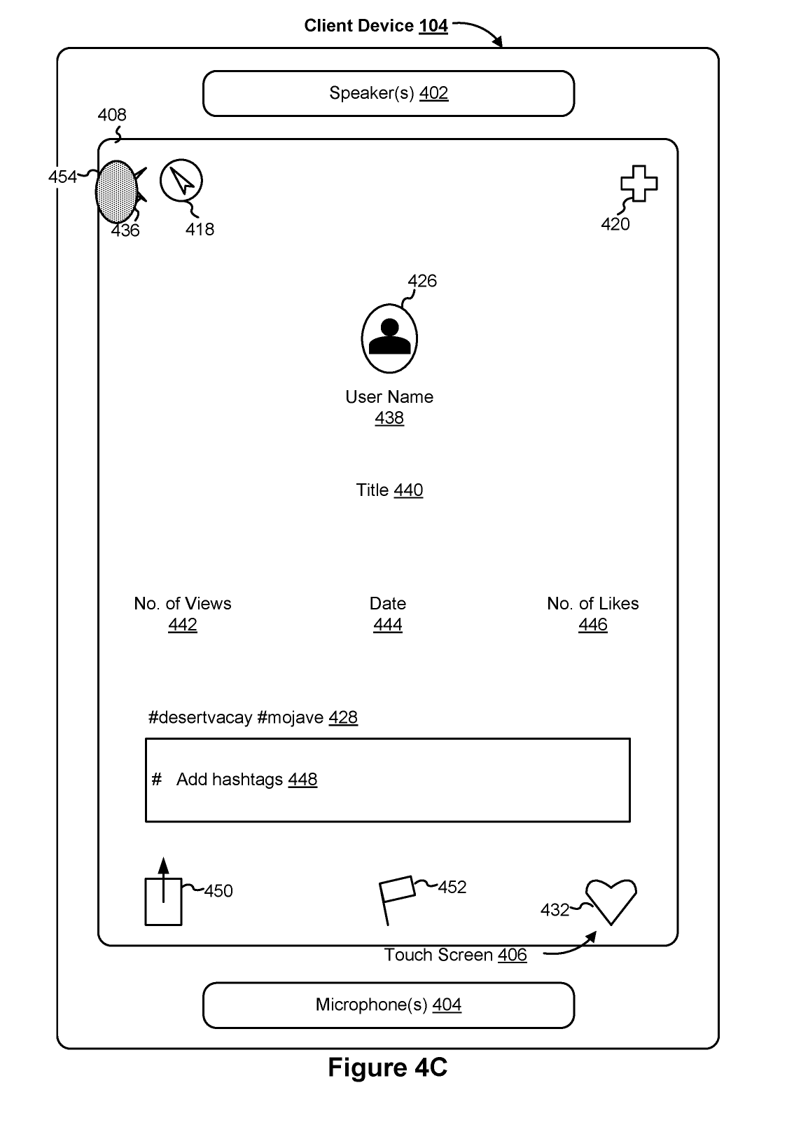

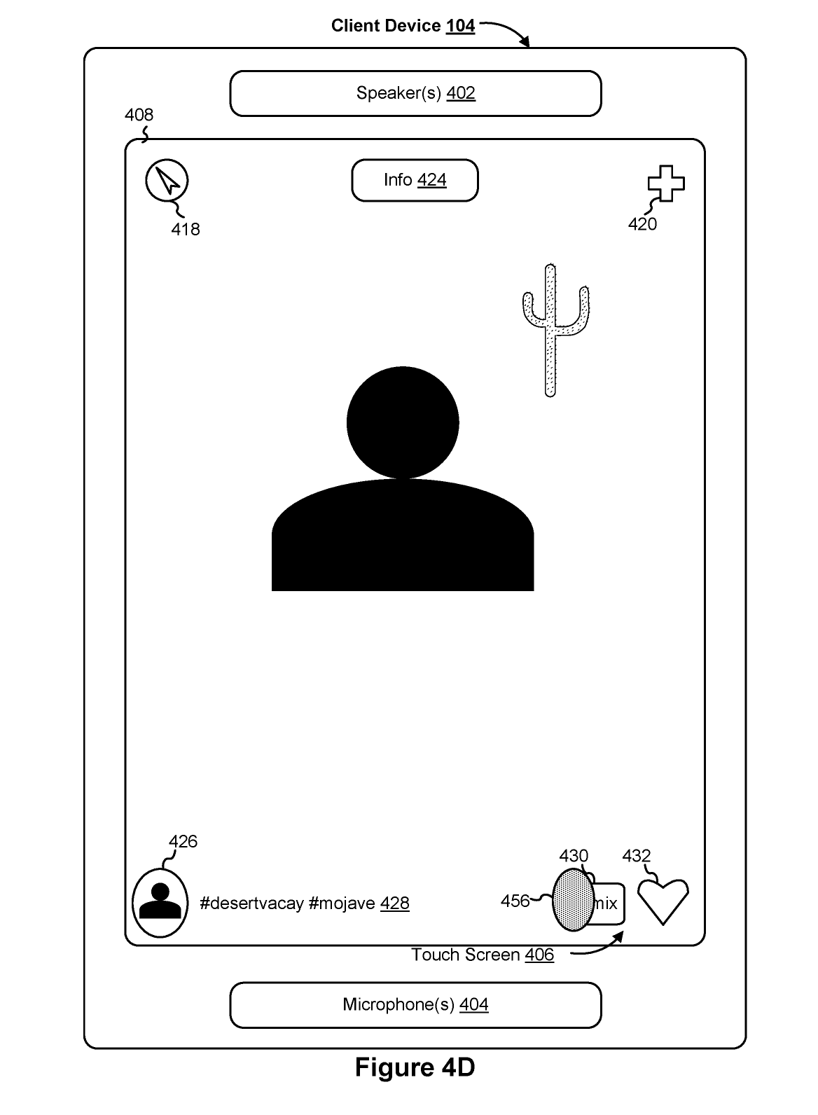

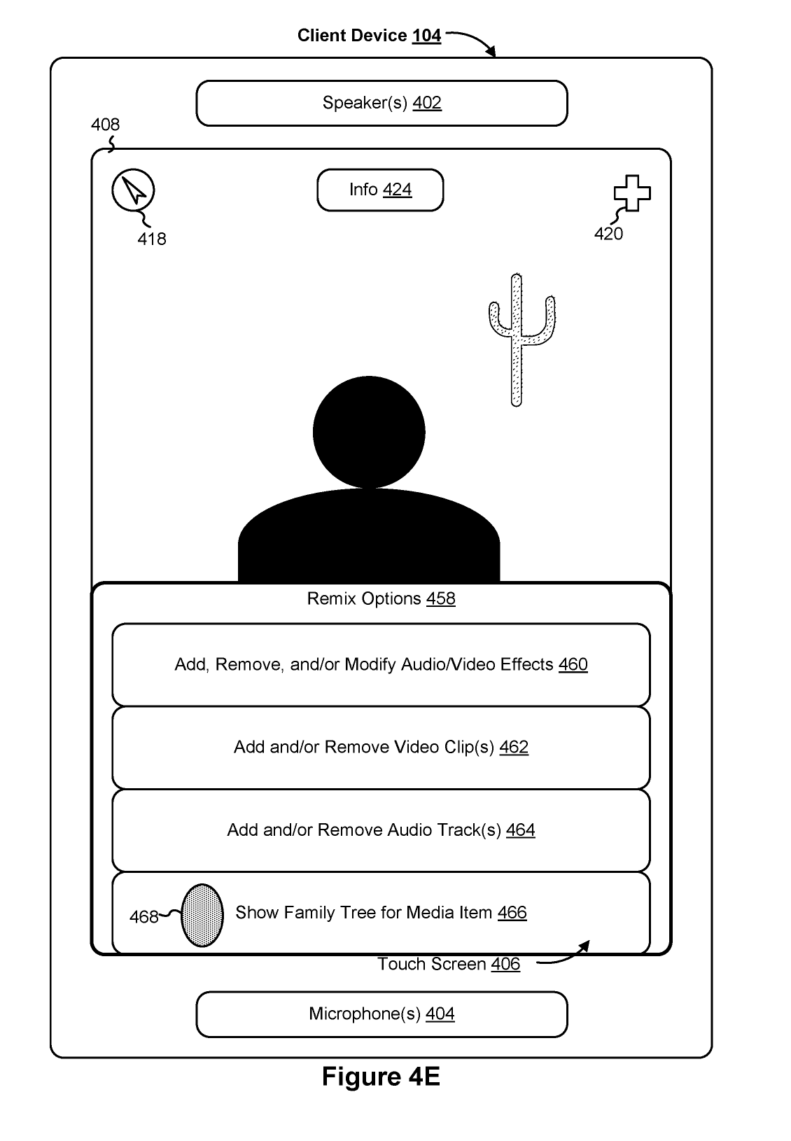

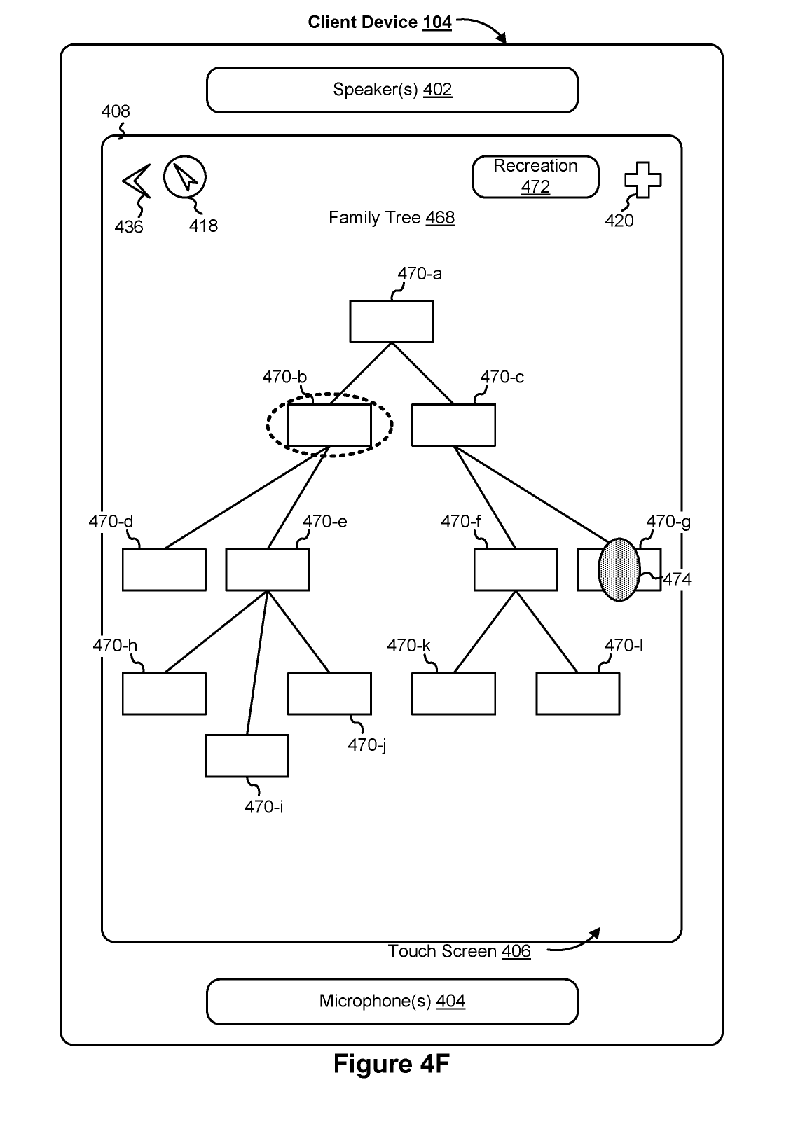

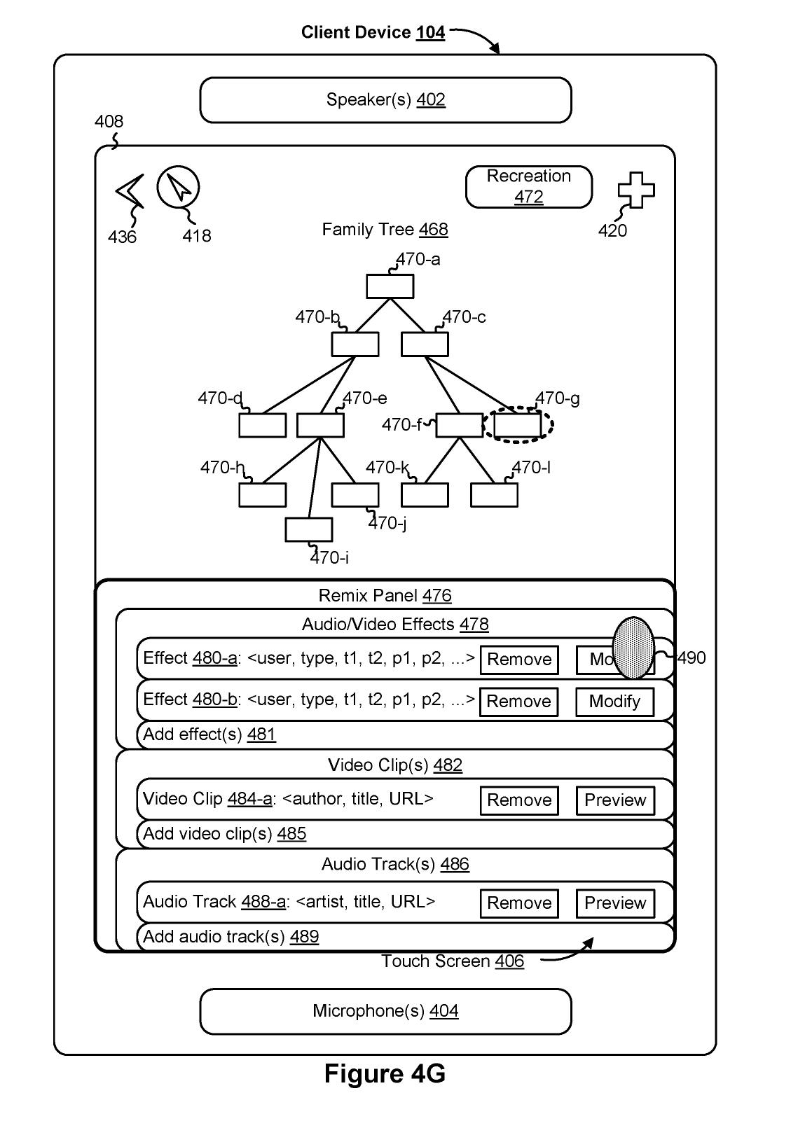

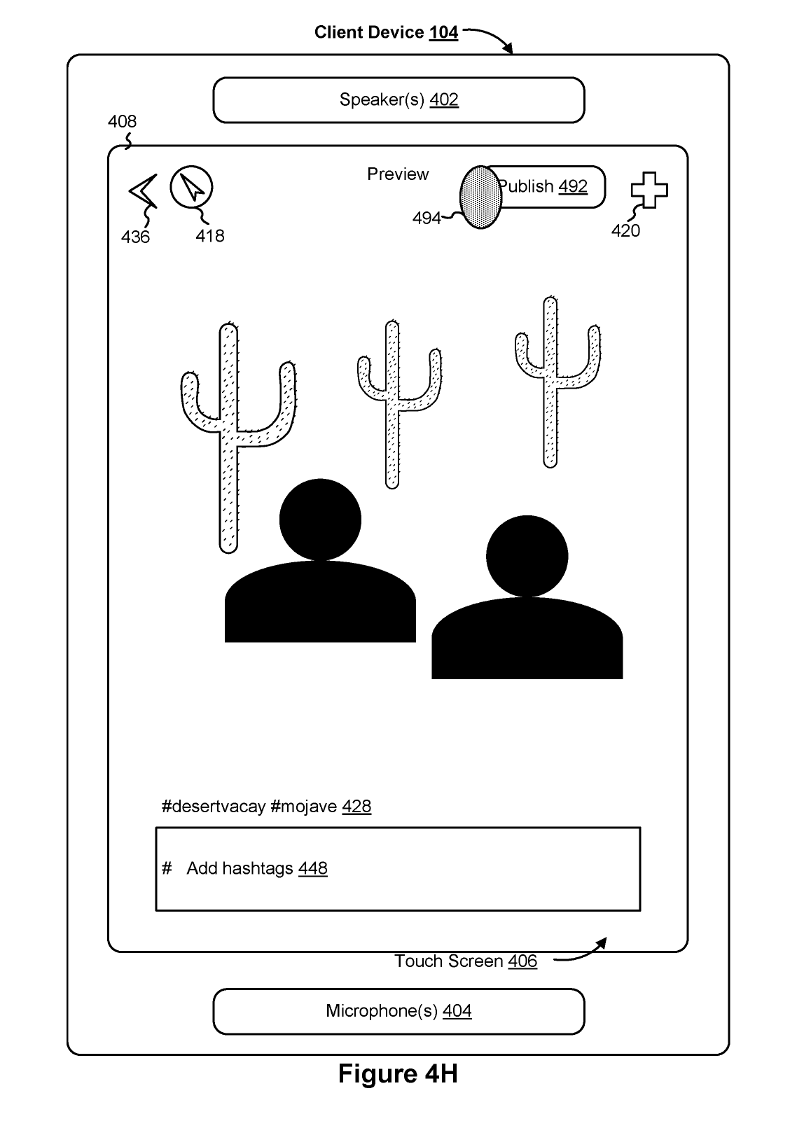

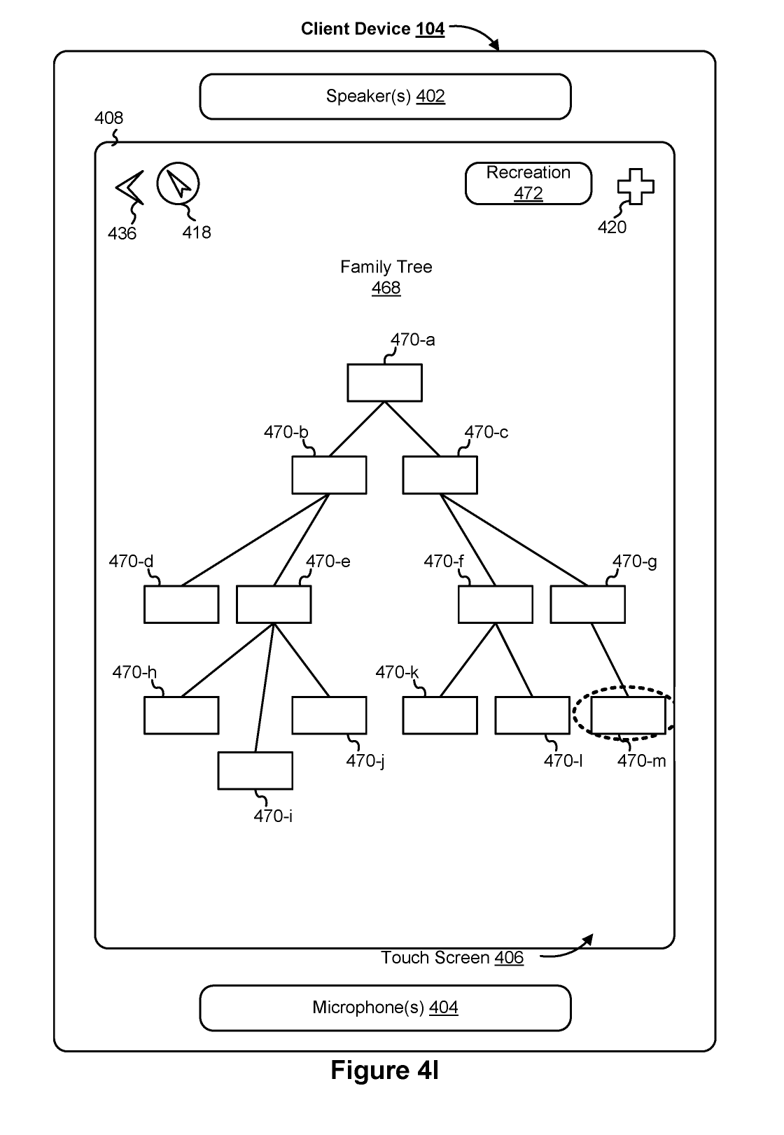

Attention is now directed towards embodiments of user interfaces and associated processes that may be implemented on a respective client device 104 with one or more speakers 402 enabled to output sound, zero or more microphones 404 enabled to receive sound input, and a touch screen 406 enabled to receive one or more contacts and display information (e.g., media content, webpages and/or user interfaces for an application). FIGS. 4A-4I illustrate example user interfaces for presenting and modifying a pre-existing media item in accordance with some embodiments.

Although some of the examples that follow will be given with reference to inputs on a touch screen 406 (where the touch sensitive surface and the display are combined), in some embodiments, the device detects inputs on a touch-sensitive surface that is separate from the display. In some embodiments, the touch sensitive surface has a primary axis that corresponds to a primary axis on the display. In accordance with these embodiments, the device detects contacts with the touch-sensitive surface at locations that correspond to respective locations on the display. In this way, user inputs detected by the device on the touch-sensitive surface are used by the device to manipulate the user interface on the display of the device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures, etc.), it should be understood that, in some embodiments, one or more of the finger inputs are replaced with input from another input device (e.g., a mouse based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

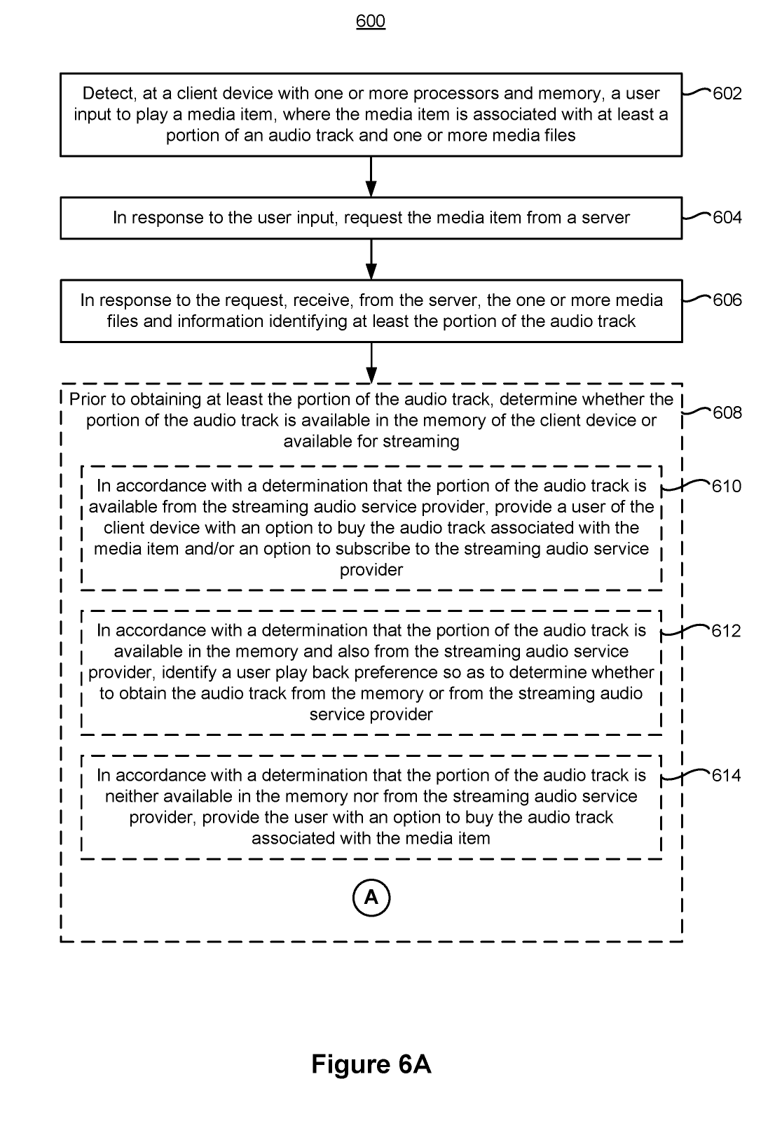

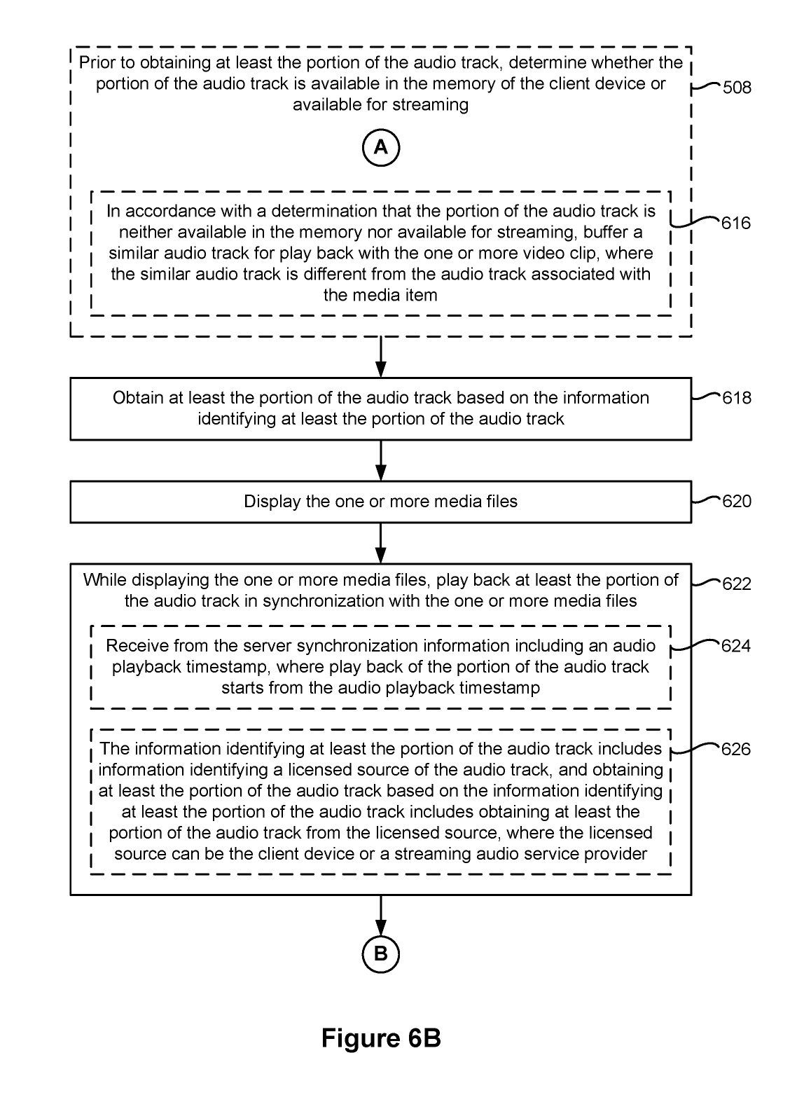

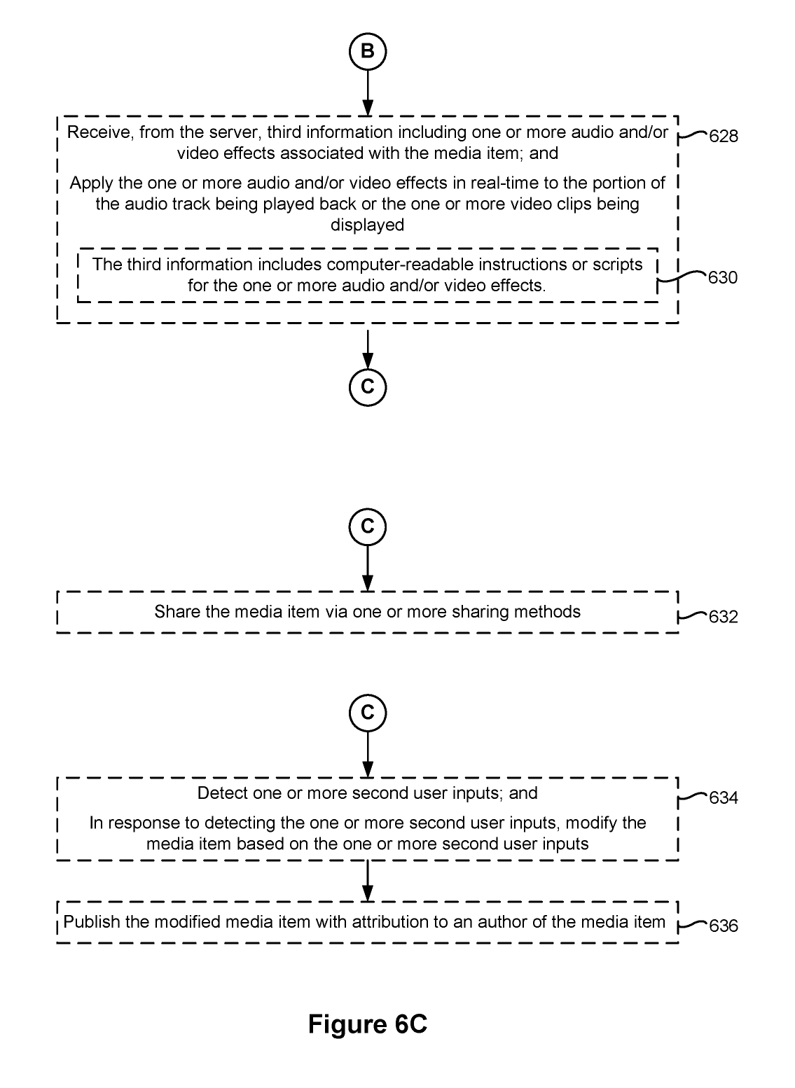

FIGS. 4A-4I show a user interface 408 displayed on a client device 104 (e.g., a mobile phone) for an application for generating, exploring, and presenting media items; however, one skilled in the art will appreciate that the user interfaces shown in FIGS. 4A-4I may be implemented on other similar computing devices. The user interfaces in FIGS. 4A-4I are used to illustrate the processes described herein, including the processes described with respect to FIGS. 6A-6C, 7A-7B, 11, and 12A-12C.

FIG. 4A illustrates a client device 104 displaying a user interface for a feed view of the application that includes a feed of media items on a touch screen 406. In FIG. 4A, the user interface includes a plurality of media item affordances 410 corresponding to media items generated by users in a community of users and a search query box 416 configured to enable the user of a client device 104 to search for media items. In some embodiments, media item affordances 410 corresponding to sponsored media items are displayed at the top or near the top of the feed of media items. In some embodiments, advertisements are concurrently displayed with the feed of media items such as banner advertisements or advertisements in a side region of the user interface. In some embodiments, one or more of the media item affordances 410 correspond to media items that are advertisements. In FIG. 4A, each of the media item affordances 410 includes a title 412 of the corresponding media item and a representation 414 of the user in the community of users who authored the corresponding media item. For example, each of the representations 414 includes an image associated with the author of the media item (e.g., a headshot or avatar) or an identifier, name, or handle associated with the author of the media item. In some embodiments, a respective representation 414, when activated (e.g., by a touch input from the user), causes a client device 104 to display a profile associated with the author of the corresponding media item.

In FIG. 4A, the user interface also includes a navigation affordance 418, which, when activated (e.g., by a touch input from the user), causes a client device 104 to display a navigation panel for navigating between user interfaces of the application (e.g., one or more of a feed view, user profile, user media items, friends view, exploration view, settings, and so on) and a creation affordance 420, which, when activated (e.g., by a touch input from the user), causes a client device 104 to display a first user interface of a process for generating a media item. For further description of the process for generating a media item see U.S. Provisional Patent Application No. 61/934,665, Attorney Docket No. 103337-5002, entitled “Methods and Devices for Touch-Based Media Creation,” filed Jan. 31, 2014, which is hereby incorporated by reference in its entirety. In FIG. 4A, the user interface includes a portion of media item affordances 410-g and 410-h indicating that the balance of the media items can be viewed by scrolling downwards in the feed view. FIG. 4A also illustrates a client device 104 detecting contact 422 at a location corresponding to media item affordance 410-b.

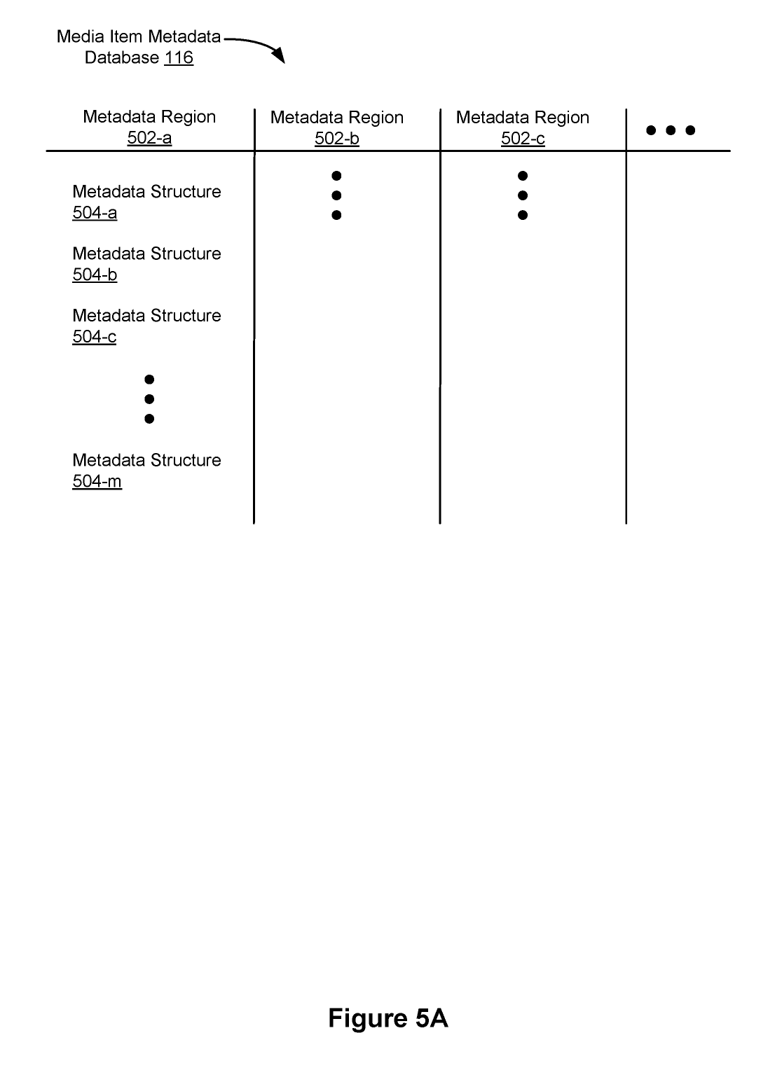

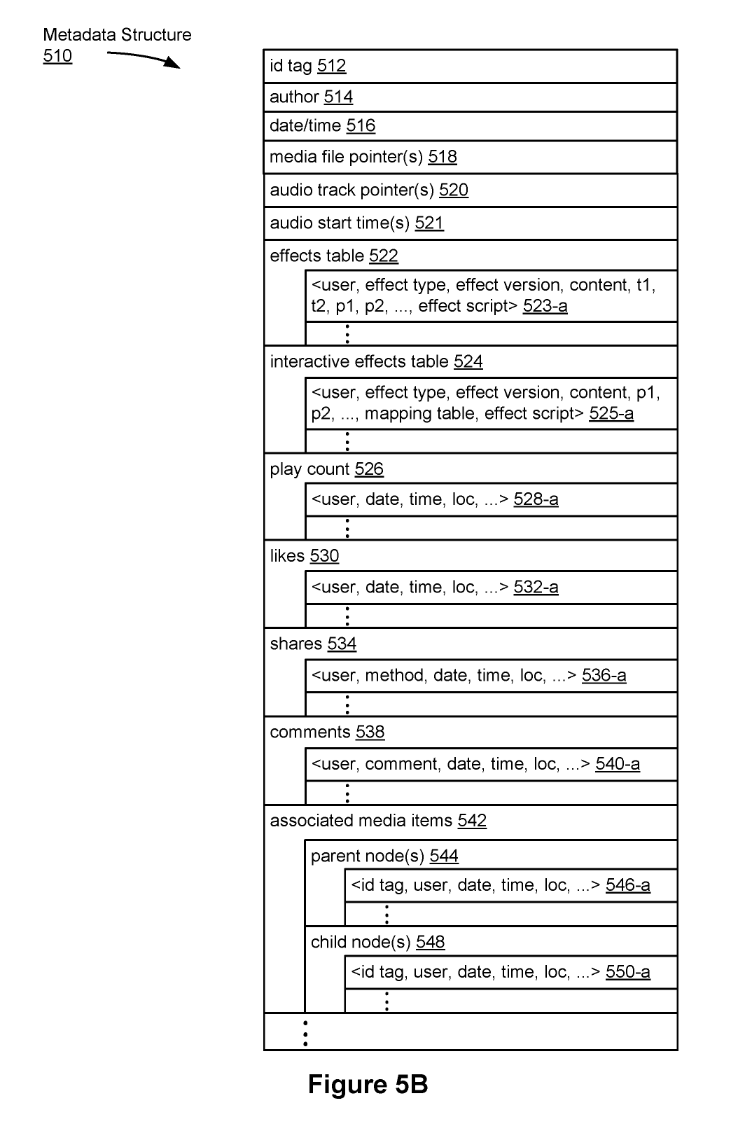

FIG. 4B illustrates a client device 104 presenting a respective media item on a touch screen 406 that corresponds to media item affordance 410-b in response to detecting contact 422 selecting media item affordance 410-b in FIG. 4A. In FIG. 4B, the user interface includes the information affordance 424, which, when activated (e.g., by a touch input from the user), causes the client device 104 to display an informational user interface (e.g., the user interface in FIG. 4C) with information and one or more options associated with the respective media item and a representation 426, which, when activated (e.g., by a touch input from the user), causes the client device 104 to display a profile associated with the author of the respective media item. For example, a representation 426 is an image associated with the author of the respective media item (e.g., a headshot or avatar) or an identifier, name, or handle associated with the author of the respective media item. In FIG. 4B, the user interface also includes hashtags 428 associated with the respective media item, a remix affordance 430, which, when activated (e.g., by a touch input from the user), causes the client device 104 to display a remix panel (e.g., the remix options 458 in FIG. 4E) for modifying the respective media item, and a like affordance 432, which, when activated (e.g., by a touch input from the user), causes the client device 104 to send a notification to a server system 108 to update a like field in the metadata structure associated with the respective media item (e.g., the likes field 530 in FIG. 5B). For example, in response to receiving the notification, a server system 108 or a component thereof (e.g., an updating module 322, FIG. 3) updates the likes field 530, as shown in FIG. 5B, in a metadata structure associated with the media item to reflect the notification. For example, in response to detecting contact 422 selecting the media item affordance 410-b in FIG. 4A, the client device 104 sends a notification to a server system 108 to update a play count field in the metadata structure associated with the respective media item (e.g., the play count field 526 in FIG. 5B). In this example, in response to receiving the notification, a server system 108 or a component thereof (e.g., the updating module 322, FIG. 3) updates the play count field 526, as shown in FIG. 5B, in a metadata structure associated with the media item to reflect the notification. FIG. 4B also illustrates a client device 104 detecting contact 434 at a location corresponding to an information affordance 424.

In some embodiments, advertisements are concurrently displayed with the respective media item such as banner advertisements or advertisements in a side region of the user interface. In some embodiments, owners of copyrighted audio tracks and video clips upload at least a sample of the audio tracks and video clips to a reference database 344 (FIG. 3) associated with the provider of the application. For example, prior to or while presenting the respective media item, a server system 108 or a component thereof (e.g., the analyzing module 326, FIG. 3) analyzes the one or more audio tracks and one or more video clips associated with the respective media item to determine a digital fingerprint for the one or more audio tracks and one or more video clips. In some embodiments, when a server system 108 or a component thereof (e.g., the determining module 328, FIG. 3) determines that the digital fingerprint for the one or more audio tracks and one or more video clips associated with the respective media item matches copyrighted audio tracks and/or video clips in a reference database 344, a server system 108 or a component thereof is configured to share advertising revenue with the owners of copyrighted audio tracks and/or video clips.

FIG. 4C illustrates a client device 104 displaying the informational user interface associated with the respective media item on a touch screen 406 in response to detecting contact 434 selecting the information affordance 424 in FIG. 4B. In FIG. 4C, the informational user interface comprises information associated with the respective media item, including: a representation 426 associated with the author of the respective media item; the title 440 of the respective media item; the number of views 442 of the respective media item; the date/time 444 on which the respective media item was authored; and the number of likes 446 of the respective media item. In FIG. 4C, the informational user interface also includes pre-existing hashtags 428 associated with the respective media item and a text entry box 448 for adding a comment or hashtag to the respective media item. For example, when a user adds a comment or hashtag, the client device 104 sends a notification to a server system 108 to update a comment field in the metadata structure associated with the respective media item (e.g., the comments field 538 in FIG. 5B). In this example, in response to receiving the notification, a server system 108 or a component thereof (e.g., the updating module 322, FIG. 3) updates the comments field 538, as shown in FIG. 5B, in a metadata structure associated with the media item to reflect the notification.

In FIG. 4C, the informational user interface further includes one or more options associated with the respective media. In FIG. 4C, the share affordance 450, when activated (e.g., by a touch input from the user), causes the client device 104 to display a sharing panel with a plurality of options for sharing the respective media item (e.g., affordances for email, SMS, social media outlets, etc.), a flag affordance 452, when activated (e.g., by a touch input from the user), causes the client device 104 to send a notification to a server system 108 to flag the respective media item (e.g., for derogatory, inappropriate, or potentially copyrighted content), and the like affordance 432, when activated (e.g., by a touch input from the user), causes the client device 104 to send a notification to a server system 108 to update a like field in the metadata structure associated with the respective media item (e.g., the likes field 530 in FIG. 5B). In FIG. 4C, the informational user interface additionally includes a back navigation affordance 436, which, when activated (e.g., by a touch input from the user), causes the client device 104 to display a previous user interface (e.g., the user interface in FIG. 4B). FIG. 4C also illustrates the client device 104 detecting contact 454 at a location corresponding to the back navigation affordance 436.

FIG. 4D illustrates a client device 104 presenting the respective media item on a touch screen 406 that corresponds to the media item affordance 410-b in response to detecting contact 454 selecting the back navigation affordance 436 in FIG. 4C. FIG. 4D also illustrates the client device 104 detecting contact 456 at a location corresponding to the remix affordance 430.

FIG. 4E illustrates a client device 104 displaying remix options 458 over the respective media item being presented on a touch screen 406 in response to detecting a contact 456 selecting the remix affordance 430 in FIG. 4D. In FIG. 4E, the remix options 458 include: an affordance 460 for adding, removing, and/or modifying audio and/or video effect associated with the respective media item; an affordance 462 for adding and/or removing one or more video clips associated with the respective media item; an affordance 464 for adding and/or removing one or more audio tracks associated with the respective media item; and an affordance 466, which, when activated (e.g., by a touch input from the user), causes the client device 104 to display a family tree user interface associated with the respective media item (e.g., the user interface in FIG. 4F). FIG. 4E also illustrates a client device 104 detecting contact 468 at a location corresponding to the affordance 466.

Alternatively, in some embodiments, in response to detecting contact 456 selecting the remix affordance 430 in FIG. 4D, a client device 104 enters a remix mode for editing the respective media item. In the remix mode, the client device 104 displays a sequence of representations corresponding to the one or more video clips comprising the respective media item. While in the remix mode, the user of the client device 104 is able to remove or reorder video clips associated with the respective media item by performing one or more gestures with respect to the representations in the sequence of representations. Furthermore, while in the remix mode, the user of the client device 104 is able to shoot one or more additional video clips, apply different audio and/or video effects, and/or change the audio track associated with the respective media item.

FIG. 4F illustrates a client device 104 displaying the family tree user interface associated with the respective media item on a touch screen 406 in response to detecting contact 468 selecting the affordance 466 in FIG. 4E. In FIG. 4F, the family tree user interface includes a family tree 468 associated with the respective media item. In FIG. 4F, the family tree 468 includes a genesis node (e.g., node 470-a) corresponding to a root media item (i.e., the original media item) for the family tree 468 and a plurality of leaf nodes (e.g., nodes 470-b, 470-c, 470-d, 470-e, 470-f, 470-g, 470-h, 470-i, 470-j, 470-k, and 470-l) corresponding to media items that are modified versions of the root media item. In some embodiments, the user of the client device 104 is able to view and/or modify the characteristics associated with any of the nodes in the family tree 468 by selecting a node (e.g., with a tap gesture). In FIG. 4F, the dotted oval surrounding a node 470-b indicates the currently selected node, i.e., the node 470-b corresponding to the respective media item.

In some embodiments, each of the leaf nodes in a family tree 468 are associated with one parent node and zero or more leaf nodes. For example, with respect to the node 470-b corresponding to the respective media item, a genesis node 470-a is its parent node and two leaf nodes (i.e., 470-d and 470-e) are its child nodes. In FIG. 4F, the family tree user interface also includes a back navigation affordance 436, which, when activated (e.g., by a touch input from the user), causes the client device 104 to display a previous user interface (e.g., the user interface in FIG. 4D), a navigation affordance 418, which, when activated (e.g., by a touch input from the user), causes the client device 104 to display a navigation panel for navigating between user interfaces of the application (e.g., one or more of a feed view, user profile, user media items, friends view, exploration view, settings, and so on), and a creation affordance 420, which, when activated (e.g., by a touch input from the user), causes the client device 104 to display a first user interface of a process for generating a media item. In FIG. 4F, the family tree user interface further includes a recreation affordance 472, which, when activated (e.g., by a touch input from the user), causes the client device 104 to present an evolutionary history or a step-by-step recreation of modifications from the genesis node to the currently selected node. FIG. 4F also illustrates the client device 104 detecting contact 474 at a location corresponding to a node 470-g.

FIG. 4G illustrates a client device 104 displaying a remix panel 476 in the family tree user interface on a touch screen 406 in response to detecting contact 474 selecting the node 470-g in FIG. 4F. In FIG. 4G, the dotted oval surrounding a node 470-g indicates the currently selected node. In FIG. 4G, a remix panel 476 enables the user of the client device 104 to view and/or modify the characteristics (e.g., audio and/or video effects, video clip(s), and audio track(s)) of the media item associated with the node 470-g. In FIG. 4G, a remix panel 476 includes audio and/or video effects region 478, a video clip(s) region 482, and an audio track(s) region 486. In FIG. 4G, the audio and/or video effects region 478 includes affordances for removing or modifying effects (e.g., 480-a and 480-b) associated with the media item corresponding to the node 470-g and an affordance 481 for adding one or more additional audio and/or video effects to the media item corresponding to the node 470-g. In FIG. 4G, a video clip(s) region 482 includes affordances for removing or modifying a video clip 484-a associated with the media item corresponding to the node 470-g and an affordance 485 for adding one or more video clips to the media item corresponding to the node 470-g. For example, the user of the client device 104 is able to shoot one or more additional video clips or select one or more additional pre-existing video clips from a media file source 126 (e.g., YouTube, Vimeo, etc.). In FIG. 4G, the audio track(s) region 486 includes affordances for removing or modifying an audio track 488-a associated with the media item corresponding to the node 470-g and an affordance 489 for adding one or more audio tracks to the media item corresponding to the node 470-g. For example, the user of the client device 104 is able to select one or more additional pre-existing audio tracks from an audio library 260 (FIG. 2) and/or a media file source 126 (e.g., SoundCloud, Spotify, etc.). FIG. 4G also illustrates the client device 104 detecting contact 490 at a location corresponding to the modify affordance for an effect 480-a. For example, in response to detecting contact 490 selecting the modify affordance for an effect 480-a, the user of the client device 104 is able to modify one or more parameters associated with the effect 480-a such as the effect type, effect version; the start time (t1) for the effect 480-a, the end time (t2) for the effect 480-a, and/or one or more preset parameters (p1, p2, . . . ) for the effect 480-a.

Alternatively, in some embodiments, in response to detecting contact 474 selecting the node 470-g in FIG. 4F, a client device 104 enters a remix mode for editing the media item corresponding to the node 470-g. In the remix mode, client device presents the media item corresponding to the node 470-g and displays a sequence of representations corresponding to the one or more video clips comprising the media item corresponding to the node 470-g. While in the remix mode, the user of the client device 104 is able to remove or reorder video clips associated with the media item by performing one or more gestures with respect to the representations in the sequence of representations. Furthermore, while in the remix mode, the user of the client device 104 is able to shoot one or more additional video clips, apply different audio and/or video effects, and/or change the audio track associated with the media item.

FIG. 4H illustrates a client device 104 displaying a preview of the modified media item on a touch screen 406 that was created in FIG. 4G from the media item corresponding to the node 470-g. In FIG. 4H, the user interface includes a back navigation affordance 436, which, when activated (e.g., by a touch input from the user), causes the client device 104 to display a previous user interface (e.g., the user interface in FIG. 4G), a navigation affordance 418, which, when activated (e.g., by a touch input from the user), causes the client device 104 to display a navigation panel for navigating between user interfaces of the application (e.g., one or more of a feed view, user profile, user media items, friends view, exploration view, settings, and so on), and a creation affordance 420, which, when activated (e.g., by a touch input from the user), causes the client device 104 to display a first user interface of a process for generating a media item. In FIG. 4H, the user interface also includes a publish affordance 492, which, when activated (e.g., by a touch input from the user), causes the client device 104 to display an updated family tree user interface (e.g., the user interface in FIG. 4I) and to cause the modified media item to be published. FIG. 4H also illustrates the client device 104 detecting contact 494 at a location corresponding to a publish affordance 492. In some embodiments, client device causes the modified media item to be published by sending, to a server system 108, first information identifying the one or more audio tracks (e.g., the audio track 488-a) associated with the modified media item, second information identifying one or more media files (e.g., a video clip 484-a) associated with the modified media item, and third information identifying the one or more audio and/or video effects (e.g., the modified version of effect 480-a and effect 480-b) associated with the modified media item.

FIG. 4I illustrates a client device 104 displaying the updated family tree user interface on a touch screen 406 in response to detecting contact 494 selecting a publish affordance 492 in FIG. 4H. In FIG. 4I, the dotted oval surrounding the node 470-m indicates the currently selected node that corresponds to the modified media item created in FIG. 4G from the media item corresponding to another node 470-g. For example, with respect to one node 470-m, another node 470-g is its parent node and it has no child nodes.

FIG. 5A is a diagram of a media item metadata database 116 in accordance with some embodiments. In some embodiments, the media item metadata database 116 is maintained by a server system 108 or a component thereof (e.g., the maintaining module 320, FIG. 3) and stores a metadata structure for each media item generated by a user in the community of users of the application. In some embodiments, the media item metadata database 116 is divided into a plurality of metadata regions 502. In some embodiments, each metadata region 502 is associated with a root media item (e.g., an original media item) and includes a family tree for the root media item. In some embodiments, a respective family tree (e.g., the family tree 468, FIG. 4I) is composed of a genesis node (e.g., the node 470-a, FIG. 4I) corresponding to the root media item and a plurality of leaf nodes (e.g., the nodes 470-b, 470-c, 470-d, 470-e, 470-f, 470-g, 470-h, 470-i, 470-j, 470-k, 470-l, and 470-m, in FIG. 4I) corresponding to media items that are modified versions of the root media item. To this end, each metadata region 502 includes a metadata structure for each node in the family tree to which it is associated. For example, the metadata region 502-a in FIG. 5A is associated with the family tree 468 in FIG. 4I. In this example, the metadata structures 504-a . . . 504-m in the metadata region 502-a correspond to each of the nodes in the family tree 468 (i.e., the nodes 470-a . . . 470-m). One of ordinary skill in the art will appreciate that the media item metadata database 116 can be arranged in various other ways.

FIG. 5B is a diagram of a representative metadata structure 510 for a respective media item in accordance with some embodiments. For example, in response to receiving information from a client device indicating that a user of the client device has generated a new media item (e.g., the respective media item), a server system 108 generates the metadata structure 510. In some embodiments, the received information at least includes first information identifying one or more audio tracks associated with the respective media item and second information identifying one or more media files (e.g., video clips or images) associated with the respective media item. In some embodiments, the received information, optionally, includes third information identifying one or more audio and/or video effects associated with the respective media item. In some embodiments, the metadata structure 510 is stored in a media item metadata database 116, as shown in FIGS. 1 and 3, and maintained by a server system 108 or a component thereof (e.g., the maintaining module 320, FIG. 3).

The metadata structure 510 includes a plurality of entries, fields, and/or tables including a subset or superset of the following:
an identification tag field 512 includes a unique identifier for the respective media item;
an author field 514 includes the identifier, name, or handle associated with the creator/author of the respective media item;
a date/time field 516 includes a date and/or time stamp associated with generation of the respective media item;
one or more media file pointer fields 518 including a pointer or link (e.g., a URL) for each of the one or more media files (e.g., video clips or images) associated with the respective media item;
one or more audio track pointer fields 520 for each of the one or more audio tracks associated with the respective media item;
one or more start time fields 521 for each of the one or more audio tracks associated with the respective media item;
an effects table 522 includes an entry 523 for each of zero or more audio and/or video effects to be applied to the respective media item at run-time upon playback by a subsequent viewer, for example, the entry 523-a includes one or more of: the identifier, name, or handle associated with the user who added the effect; the effect type; the effect version; the content (e.g., one or more media files and/or audio tracks) subjected to the effect; a start time (t1) for the effect; an end time (t2) for the effect; one or more preset parameters (p1, p2, . . . ) for the effect; a table mapping interactive input modalities to effect parameters; and an effect script or computer-readable instructions for the effect (e.g., GLSL);
an interactive effects table 524 includes an entry 525 for each of zero or more interactive audio and/or video effects to be controlled and manipulated at run-time by a subsequent viewer of the respective media item, for example, the entry 525-a includes one or more of: the identifier, name, or handle associated with the user who added the interactive effect; the interactive effect type; the interactive effect version; the content (e.g., one or more media files and/or audio tracks) subjected to the effect; one or more parameters (p1, p2, . . . ) for the interactive effect; and an effect script or computer-readable instructions for the interactive effect (e.g., GLSL);
a play count field 526 includes zero or more entries 528 for each play back of the respective media item, for example, the entry 528-a includes: the identifier, name, or handle associated with the user who played the respective media item; the date and time when the respective media item was played; and the location where the respective media item was played;
a likes field 530 includes zero or more entries 532 for each like of the respective media item, for example, the entry 532-a includes: the identifier, name, or handle associated with the user who liked the respective media item; the date and time when the respective media item was liked; and the location where the respective media item was liked;
a shares field 534 includes zero or more entries 536 for each share of the respective media item, for example, the entry 536-a includes: the identifier, name, or handle associated with the user who shared the respective media item; the method by which the respective media item was shared; the date and time when the respective media item was shared; and the location where the respective media item was shared;
a comments field 538 includes zero or more entries 540 for each comment (e.g., a hashtag) corresponding to the respective media item, for example, the entry 540-a includes: the comment; the identifier, name, or handle associated with the user who authored the comment; the date and time when the comment was authored; and the location where the comment was authored; and
an associated media items field 542 includes zero or more entries in a parent node sub-field 544 and zero or more entries in a child node sub-field 548 for each media item associated with the respective media item, for example:
   a parent node sub-field 544 includes an entry 546-a corresponding to a parent media item associated with the respective media item that includes: an identification tag for the parent media item; the identifier, name, or handle associated with the user who authored the parent media item; the date and time when the parent media item was authored; and the location where the parent media item was authored; and
   a child node sub-field 548 includes an entry 550-a corresponding to a child media item associated with the respective media item that includes: an identification tag for the child media item; the identifier, name, or handle associated with the user who authored the child media item; the date and time when the child media item was authored; and the location where the child media item was authored.

In some implementations, a metadata structure 510, optionally, stores a subset of the entries, fields, and/or tables identified above. Furthermore, the metadata structure 510, optionally, stores additional entries, fields, and/or tables not described above.

In some embodiments, an identification tag field 512 includes a node type identifier bit that is set for root media items/genesis nodes and unset for leaf nodes. In some embodiments, a parent or child node entry in a metadata structure links to a node in a different family tree (and, ergo, metadata region). In this way, in some embodiments, metadata structures are included in more than one metadata region as a node is linked to more than one family tree. In some embodiments, effect parameters include, but are not limited to: (x,y) position and scale of audio and/or video effects, edits, specification of interactive parameters, and so on.

For example, a metadata structure 510 is the metadata structure 504-b in FIG. 5A, which corresponds to a respective media item in the family tree associated with the metadata region 502-a. In this example, the family tree associated with the metadata region 502-a is the family tree 468 in FIG. 4I, and the node corresponding to metadata structure 504-b is the node 470-b. Continuing with this example, the associated media items field 542 includes the entry 546-a corresponding to a node 470-a in the parent node sub-field 544 and the entries 550-a and 550-b corresponding to nodes 470-d and 470-e in the child node sub-field 548.

FIGS. 6A-6C illustrate a flowchart diagram of a client-side method 600 of presenting a media item in accordance with some embodiments. In some embodiments, the method 600 is performed by an electronic device with one or more processors and memory. For example, in some embodiments, the method 600 is performed by a mobile device (e.g., the client device 104, FIGS. 1-2) or a component thereof (e.g., the client-side module 102, FIGS. 1-2). In some embodiments, the method 600 is governed by instructions that are stored in a non-transitory computer readable storage medium and the instructions are executed by one or more processors of the electronic device. Optional operations are indicated by dashed lines (e.g., boxes with dashed-line borders).

A client device detects (602) a user input to play the media item, where the media item is associated with at least a portion of an audio track and one or more media files (e.g., one or more video clips and/or a sequence of one or more images). For example, in FIG. 4A, the client device 104 detects contact 422 at a location corresponding to the media item affordance 410-b to play the media item associated with the media item affordance 410-b. In some other embodiments, the media item is only associated with audio or video and the application generates the missing media content (e.g., audio or video content). For example, the media item is associated with at least a portion of an audio track and the application is configured to present a visualizer that is synchronized with the portion of the audio track or to match one or more video clips or a sequence of one or more images to the portion of the audio track to be synchronized with the portion of the audio track.

In response to the user input, the client device requests (604) the media item from a server. For example, in response to detecting contact 422, in FIG. 4A, at a location corresponding to a media item affordance 410-b, the client device 104 sends a request to a server system 108 requesting the media item that corresponds to the media item affordance 410-b.

In response to the request, the client device receives (606), from the server, the one or more media files and information identifying at least the portion of the audio track. In some embodiments, the client device 104 receives, from the server system 108, one or more media files associated with the requested media item and a metadata structure, or a portion thereof, associated with the requested media item (e.g., including information identifying at least a portion of an audio track associated with the requested media item). In some embodiments, the client device 104 buffers the one or more media files received from the server system 108 in a video buffer 254 (FIG. 2) for display. In some embodiments, the client device 104 receives, from the server system 108, a metadata structure, or a portion thereof, associated with the requested media item (e.g., including information identifying one or more media files associated with the requested media item and information identifying at least a portion of an audio track associated with the requested media item). In some embodiments, a metadata structure associated with the media item is stored in a media item metadata database 116 (FIGS. 1 and 3) at a server system 108. In some embodiments, the metadata structure associated with the media item includes a pointer to each of one or more media files associated with the media item and a pointer to each of one or more audio tracks associated with the media item. In some embodiments, a respective pointer to a media file associated with the media item points to a media file stored in a media file database 114 or available from a media file source 126 (FIG. 1). In some embodiments, a respective pointer to an audio track associated with the media item points to an audio track stored in an audio library 260 (FIG. 2) associated with the user of a client device 104 or provided by an audio source 124 (FIG. 1) (e.g., a streaming audio service provider such as Spotify, SoundCloud, Rdio, Pandora, or the like).

In some embodiments, prior to obtaining at least the portion of the audio track, the client device determines (608) whether the portion of the audio track is available in the memory of the client device or available for streaming (e.g., from a streaming audio service provider such as SoundCloud, Spotify, Rdio, etc.). In some embodiments, the client device 104 or a component thereof (e.g., the determining module 230, FIG. 2) determines whether the audio track identified in the metadata structure corresponding to the media item is available in an audio library 260 (FIG. 2) and/or from one or more audio sources 124 (FIG. 1).

In some embodiments, in accordance with a determination that the portion of the audio track is available from the streaming audio service provider, the client device provides (610) a user of the client device with an option to buy the audio track associated with the media item and/or an option to subscribe to the streaming audio service provider. In some embodiments, after the client device 104 or a component thereof (e.g., the determining module 230, FIG. 2) determines that the audio track identified in the metadata structure for the media item is available from an audio source 124 (FIG. 1), the client device 104 additionally presents the user of the client device 104 with the option to buy the audio track and/or to subscribe to the audio source 124 from which the audio track is available. In some embodiments, upon presenting the media item, the client device 104 presents the user of the client device 104 with the option to buy the audio track and/or to subscribe to the audio source 124 from which the audio track is available.

In some embodiments, in accordance with a determination that the portion of the audio track is available in the memory and also from the streaming audio service provider, the client device identifies (612) a user play back preference so as to determine whether to obtain the audio track from the memory or from the streaming audio service provider. In some embodiments, after the client device 104 or a component thereof (e.g., the determining module 230, FIG. 2) determines that the audio track identified in the metadata structure for the media item is available both in an audio library 260 (FIG. 2) and from one or more audio sources 124 (FIG. 1), the client device 104 identifies a play back preference in the user profile 262 (FIG. 2). For example, when the play back preference in the user profile 262 indicates that the audio library 260 (FIG. 2) is the default, the client device 104 plays back at least the portion of the audio track from the audio library 260 in synchronization with the one or more media files. For example, when the play back preference in the user profile 262 indicates that streaming audio is the default, the client device 104 plays back at least the portion of the audio track from the audio source 124 in synchronization with the one or more media files.

In some embodiments, in accordance with a determination that the portion of the audio track is neither available neither in the memory nor from the streaming audio service provider, the client device provides (614) a user of the client device with an option to buy the audio track associated with the media item. In some embodiments, after the client device 104 or a component thereof (e.g., the determining module 230, FIG. 2) determines that the audio track identified in the metadata structure for the media item is neither available in the audio library 260 (FIG. 2) nor from one or more audio sources 124 (FIG. 1), the client device 104 presents the user of the client device 104 with the option to buy the audio track from an audio track marketplace (e.g., Amazon, iTunes, etc.).

In some embodiments, in accordance with a determination that the portion of the audio track is neither available in the memory nor available for streaming, the client device buffers (616) a similar audio track for play back with the one or more media files, where the similar audio track is different from the audio track associated with the media item. In some embodiments, as a contingency for when the audio track is unavailable, the metadata structure associated with the media item optionally includes information identifying one or more audio tracks that are similar to the audio track associated with the media item. For example, the similar audio track is a cover of the audio track associated with the media item or has a similar music composition (e.g., similar genre, artist, instruments, notes, key, rhythm, and so on) to the audio track associated with the media item. In some embodiments, after the client device 104 or a component thereof (e.g., the determining module 230, FIG. 2) determines that the audio track identified in the metadata structure for the media item is neither available in an audio library 260 (FIG. 2) nor from one or more audio sources 124 (FIG. 1), the client device 104 obtains at least a portion of a similar audio track from a source (e.g., the audio library 260 or an audio source 124) and buffers at least the portion of the similar audio track in an audio buffer 252 (FIG. 2) for play back.

The client device obtains (618) at least the portion of the audio track based on the information identifying at least the portion of the audio track. In some embodiments, after determining a source for the audio track (e.g., the audio library 260 (FIG. 2) or an audio source 124 (FIG. 1)), the client device 104 or a component thereof (e.g., the obtaining module 232, FIG. 2) obtains at least the portion of the audio track from the identified source and buffers at least the portion of the audio track in an audio buffer 252 (FIG. 2) for play back.

The client device displays (620) the one or more media files. For example, in FIG. 4B, the client device 104 or a component thereof (e.g., the presenting module 234, FIG. 2) displays on a touch screen 406 one or more media files associated with the media item that corresponds to the media item affordance 410-b selected in FIG. 4A.

While displaying the one or more media files, the client device plays back (622) at least the portion of the audio track in synchronization with the one or more media files. In some embodiments, the client device 104 or a component thereof (e.g., the presenting module 234, FIG. 2) plays back, via one or more speakers 402, at least a portion of an audio track associated with the media item. In some embodiments, the client device 104 or a component thereof (e.g., the synchronizing module 236, FIG. 2) synchronizes play back of the portion of the audio track with display of the one or more media items.

In some embodiments, the client device receives (624), from the server, synchronization information including an audio playback timestamp, where play back of the portion of the audio track starts from the audio playback timestamp. In some embodiments, the client device 104 or a component thereof (e.g., the synchronizing module 236, FIG. 2) synchronizes play back of the portion of the audio track with display of the one or more media items by starting play back of the portion of the audio track from the audio playback timestamp identified in the synchronization information (e.g., the audio start time field 521, FIG. 5B).

In some embodiments, the information identifying at least the portion of the audio track includes (626) information identifying a licensed source of the audio track, and obtaining at least the portion of the audio track based on the information identifying at least the portion of the audio track includes obtaining at least the portion of the audio track from the licensed source, where the licensed source can be the client device or a streaming audio service provider. In some embodiments, the audio track is recorded or provided by a user in the community of user associated with the application. In some embodiments, the licensed source is an audio library 260 (FIG. 2), which contains one or more audio tracks purchased by the user of the client device 104, or an audio source 124 (e.g., a streaming audio service provider such as SoundCloud, Spotify, or the like) with licensing rights to the audio track.

In some embodiments, the client device receives (628), from the server, third information including one or more audio and/or video effects associated with the media item, and the client device applies the one or more audio and/or video effects in real-time to the portion of the audio track being played back or the one or more video clips being displayed. In some embodiments, the one or more audio and/or video effects are static, predetermined effects that are stored in an effects table 522 in a metadata structure 510, as shown in FIG. 5B, and the one or more audio and/or video effects are applied to the one or more media files and/or the portion of the audio track at run-time. In some embodiments, the one or more audio and/or video effects are interactive effects that are stored in an interactive effects table 524 in a metadata structure 510, as shown in FIG. 5B, and the user of the client device 104 controls and manipulates the application of one or more audio and/or video interactive effects to the one or more media files and/or the portion of the audio track in real-time upon play back. Storage of the audio and/or video effects in the effects table 522 and/or the interactive effects table 524 enables the application to maintain original, first generation media files and audio tracks in an unadulterated and high quality form and to provide an unlimited modification functionality (e.g., remix and undo).

In some embodiments, the third information includes (630) computer-readable instructions or scripts for the one or more audio and/or video effects. For example, the client device 104 downloads effects, from a server system 108, at run-time including computer-readable instructions or scripts for the effects written in a language such as GLSL, accompanied by effect metadata indicating effect type, effect version, effect parameters, a table mapping interactive modalities (e.g., touch, gesture, sound, vision, etc.) to effect parameters, and so on. In this way, the choice, number, and type of effect can be varied at run-time. In some embodiments, a web-based content management server (CMS) is available for the real-time browser-based authoring and uploading of effects to the server, including real-time preview of effects on video and/or audio (e.g., using technologies such as WebGL). In some embodiments, the audio and/or video effects have interactive components that are specified and customized by authors via the CMS, and then are controlled and manipulated at run-time via user inputs.

In some embodiments, the client device shares (632) the media item via one or more sharing methods. For example, the share affordance 450, in FIG. 4C, causes the client device 104 to display a sharing panel with a plurality of options for sharing the respective media item (e.g., affordances for email, SMS, social media outlets, etc.). In this example, in response to detecting a user input selecting one of the options in the sharing panel, the client device 104 sends, to a server system 108, a command to share the media item presented in FIG. 4B. Continuing with this example, in response to receiving the command, the server system 108 causes a link to the media item to be placed on a profile page in social media application corresponding to the user of the client device 104. In some embodiments, the server system 108 or a component thereof (e.g., the modifying module 330, FIG. 3) generates a flattened version of the media item by combining the one or more audio tracks, one or more video clips, and zero or more effects associated with the media item into a single stream or digital media item. In some embodiments, the link placed on the profile page in social media application corresponds to the flattened version of the media item for web browsers.

In some embodiments, sharing the media item is accomplished by a specialized web player that recreates a subset of the functions of the application and runs in a web browser, such as some combination of: synchronizing audio and video streams from different sources during playback; applying real-time effects; allowing interaction with the player; allowing sharing and re-sharing of the media item on social networks or embedded in web pages, etc.

In some embodiments, the client device detects (634) one or more second user inputs, and, in response to detecting the one or more second user inputs, the client device modifies the media item based on the one or more second user inputs. For example, the client device 104 detects one or more second user inputs selecting the affordance 464, in FIG. 4E, to add and/or remove one or more audio tracks associated with the media item presented in FIGS. 4B and 4D that corresponds to the affordance 410-b. In this example, the user of the client device selects a cover audio track from an audio library 260 (FIG. 2) or an audio source 124 (FIG. 1) to replace the audio track associated with the media item. In some embodiments, this requires that the server system determine a corresponding start time (synchronization information) for the cover audio track. Continuing with this example, the client device 104 creates a modified media item based on the media item presented in FIGS. 4B and 4D that corresponds to the affordance 410-b.

In some embodiments, the client device publishes (636) the modified media item with attribution to an author of the media item. In some embodiments, in response to one or more second user inputs modifying the media item presented in FIGS. 4B and 4D that corresponds to the affordance 410-b, the client device 104 publishes the modified media item by sending, to a server system 108, first information identifying the one or more audio tracks associated with the modified media item (e.g., the selected cover of the audio track associated with the media item presented in FIGS. 4B and 4D), second information identifying one or more media files associated with the modified media item, and third information identifying the one or more audio and/or video effects associated with the modified media item. In some embodiments, attribution is given to an author of individual new or modified media items and metadata. For example, with reference to FIG. 5B, each entry 523 in an effects table 522 includes the identifier, name, or handle associated with the user who added the effect.

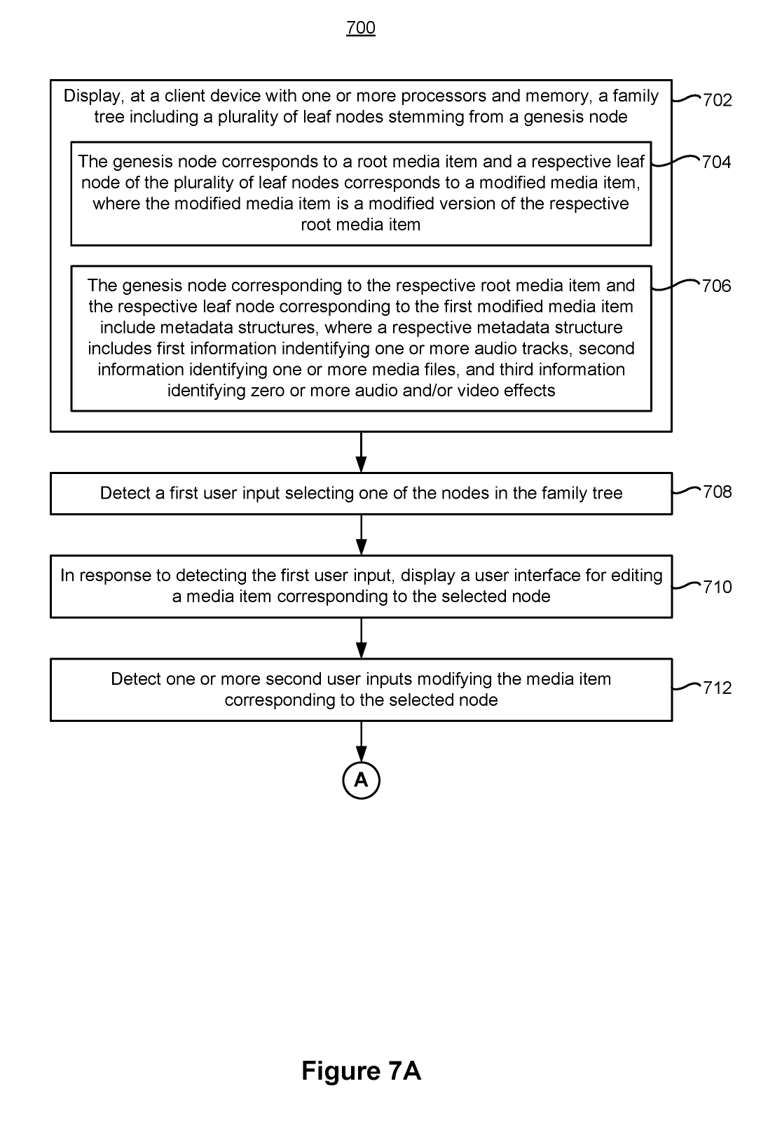

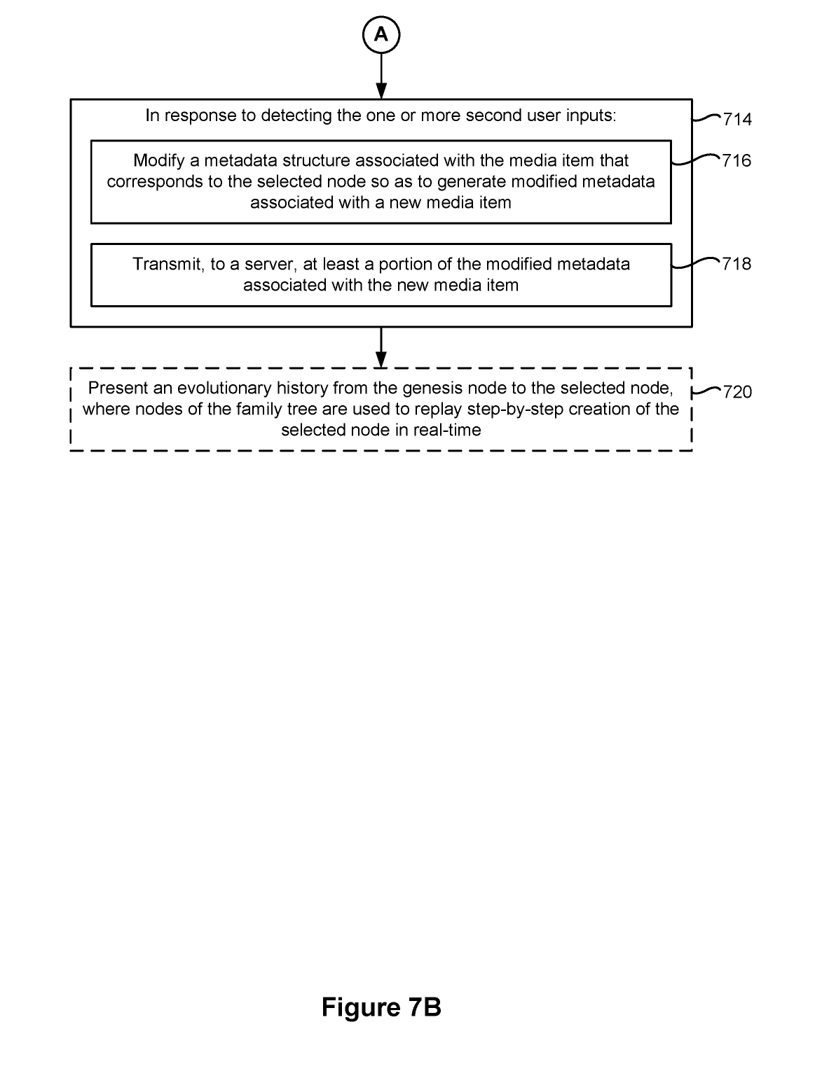

FIGS. 7A-7B illustrate a flowchart diagram of a client-side method 700 of modifying a pre-existing media item in accordance with some embodiments. In some embodiments, the method 700 is performed by an electronic device with one or more processors and memory. For example, in some embodiments, the method 700 is performed by a mobile device (e.g., the client device 104, FIGS. 1-2) or a component thereof (e.g., the client-side module 102, FIGS. 1-2). In some embodiments, the method 700 is governed by instructions that are stored in a non-transitory computer readable storage medium and the instructions are executed by one or more processors of the electronic device. Optional operations are indicated by dashed lines (e.g., boxes with dashed-line borders).

The client device displays (702) a family tree associated with a root media item including a plurality of leaf nodes stemming from a genesis node. FIG. 4F, for example, shows the client device 104 displaying a family tree 468 with a genesis node 470-a and a plurality of leaf nodes 470-b, 470-c, 470-d, 470-e, 470-f, 470-g, 470-h, 470-i, 470-j, 470-k, and 470-l. In some embodiments, the root media item is a professionally created video (e.g., a music video, film clip, or advertisement) either in “flat” format or in the metadata-annotated format with media items and metadata.

The genesis node corresponds to (704) a root media item and a respective leaf node of the plurality of leaf nodes corresponds to a modified media item, where the modified media item is a modified version of the respective root media item. In FIG. 4F, for example, the genesis node 470-a corresponds to a root media item (i.e., the original media item) for the family tree 468 and the leaf nodes 470-b, 470-c, 470-d, 470-e, 470-f, 470-g, 470-h, 470-i, 470-j, 470-k, and 470-l correspond to media items that are modified versions of the root media item.

The genesis node corresponding to (706) the root media item and the respective leaf node corresponding to the first modified media item include metadata structures, where a respective metadata structure includes first information identifying one or more audio tracks, second information identifying one or more media files, and third information identifying zero or more audio and/or video effects. In some embodiments, a media item metadata database 116 stores a metadata structure for each media item generated by a user in the community of users of the application. For example, the metadata region 502-a of the media item metadata database 116, in FIG. 5A, corresponds to the family tree 468, and the metadata structures 504-a, . . . , 504-m correspond to nodes 470-a, . . . , 470-m of the family tree 468 in FIG. 51. In this example, the metadata structure 510, in FIG. 5B, corresponds to the metadata structure 504-b in FIG. 5A, which corresponds to a respective media item in the family tree associated with the metadata region 502-a. Continuing with this example, the family tree associated with the metadata region 502-a is the family tree 468 in FIG. 4I, and the node corresponding to the metadata structure 504-b is the node 470-b in FIG. 4I. The metadata structure 510, in FIG. 5B, includes one or more audio track pointer fields 520 for each of the one or more audio tracks associated with the media item, the one or more media file pointer fields 520 for each of the one or more media files associated with the media item, and the effects table 522 with entries 523 for each of zero or more audio and/or video effects to be applied to the respective media item at run-time.

The client device detects (708) a first user input selecting one of the nodes in the family tree. For example, in FIG. 4F, the client device 104 detects contact 474 selecting a node 470-g in the family tree 468. Alternatively, in some embodiments, the client device 104 detects a first user input to modify or remix a media item, where the family tree is not displayed or otherwise visualized. For example, with respect to FIG. 4D, the client device 104 detects contact 456 selecting the remix affordance 430 to modify the respective media item being presented in FIGS. 4B and 4D.

In response to detecting the first user input, the client device displays (710) a user interface for editing a media item corresponding to the selected node. For example, in FIG. 4G, the client device 104 displays the remix panel 476 in the family tree user interface in response to detecting contact 474 selecting the node 470-g in FIG. 4F. For example, the remix panel 476 enables the user of the client device 104 to re-order, add, or remove one or more audio tracks and/or one or more video clips associated with the media item corresponding to the node 470-g, or to add, remove, or modify one or more audio and/or video effects associated with the media item corresponding to the node 470-g.

The client device detects (712) one or more second user inputs modifying the media item corresponding to the selected node. For example, in response to detecting contact 490, in FIG. 4G, selecting the modify affordance for the effect 480-a, the user of the client device 104 is able to modify one or more parameters associated with the effect 480-a such as the effect type, the effect version, the start time (t1) for the effect 480-a, the end time (t2) for the effect 480-a, and/or one or more preset parameters (p1, p2, . . . ) for the effect 480-a.

In response to detecting the one or more second user inputs (714), the client device modifies (716) a metadata structure associated with the media item that corresponds to the selected node so as to generate modified metadata associated with a new media item. For example, in response to detecting the one or more second user inputs modifying one or more parameters associated with an effect 480-a, the client device 104 or a component thereof (e.g., the modifying module 242, FIG. 2) modifies an entry corresponding to the effect 480-a in the effects table of the metadata structure for the node 470-g so as to generate modified metadata associated with a new media item.

In response to detecting the one or more second user inputs (714), the client device transmits (718), to a server, at least a portion of the modified metadata associated with the new media item. In some embodiments, in response to detecting the one or more second user inputs modifying one or more parameters associated with an effect 480-a, the client device 104 or a component thereof (e.g., the publishing module 244, FIG. 2) transmits at least a portion of the modified metadata to a server system 108. For example, after modifying a pre-existing media item corresponding to a node 470-g in the family tree 468, in FIG. 4G, so as to generate a new media item, the client device 104 publishes the new media item by sending, to the server system 108, first information identifying the one or more audio tracks associated with the new media item (e.g., an audio track 488-a), second information identifying one or more media files associated with the new media item (e.g., a video clip 484-a), and third information identifying the one or more audio and/or video effects of associated with the new media item (e.g., the modified effect 480-a and another effect 480-b).

In some embodiments, the client device presents (720) an evolutionary history from the genesis node to the selected node, where nodes of the family tree are used to replay step-by-step creation of the selected node in real-time. For example, with respect to FIG. 4I, client device detects a user input selecting a recreation affordance 472. In this example, in response to detecting the user input selecting the recreation affordance 472, the client device 104 presents an evolutionary history or a step-by-step recreation of modifications from the genesis node (e.g., the node 470-a) to the currently selected node (e.g., the node 470-m).

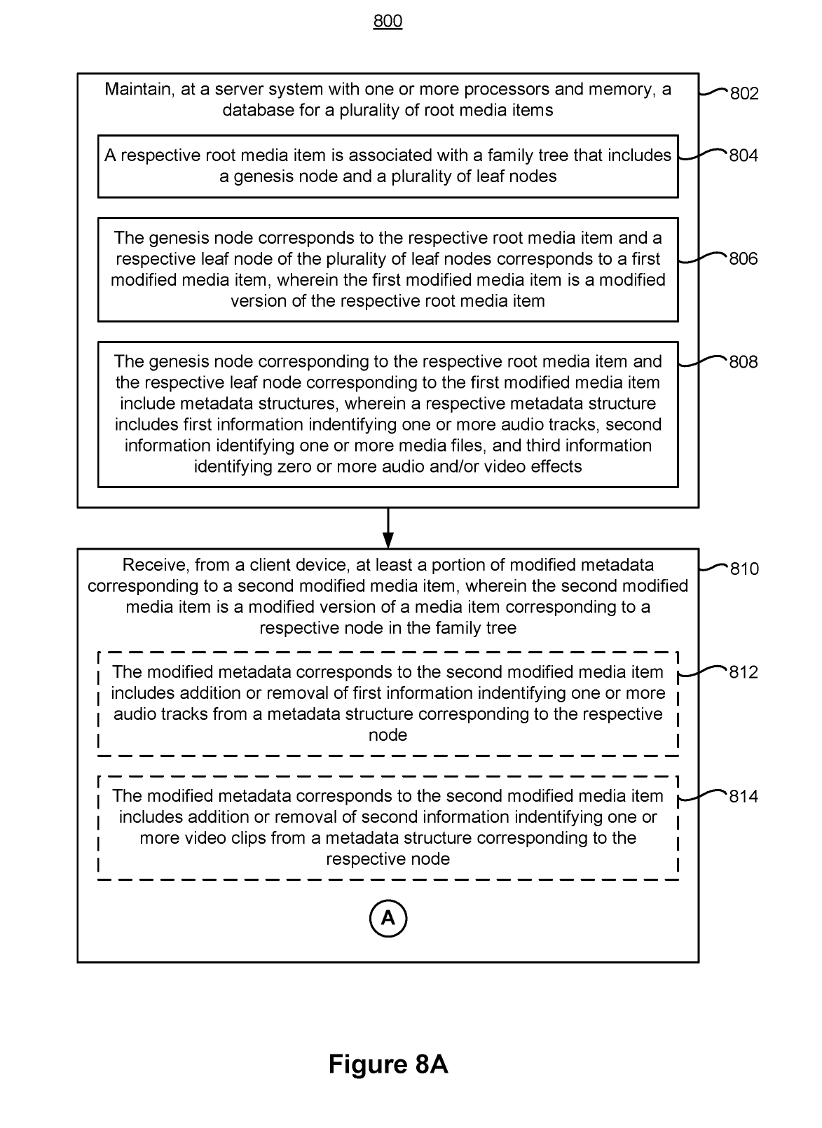

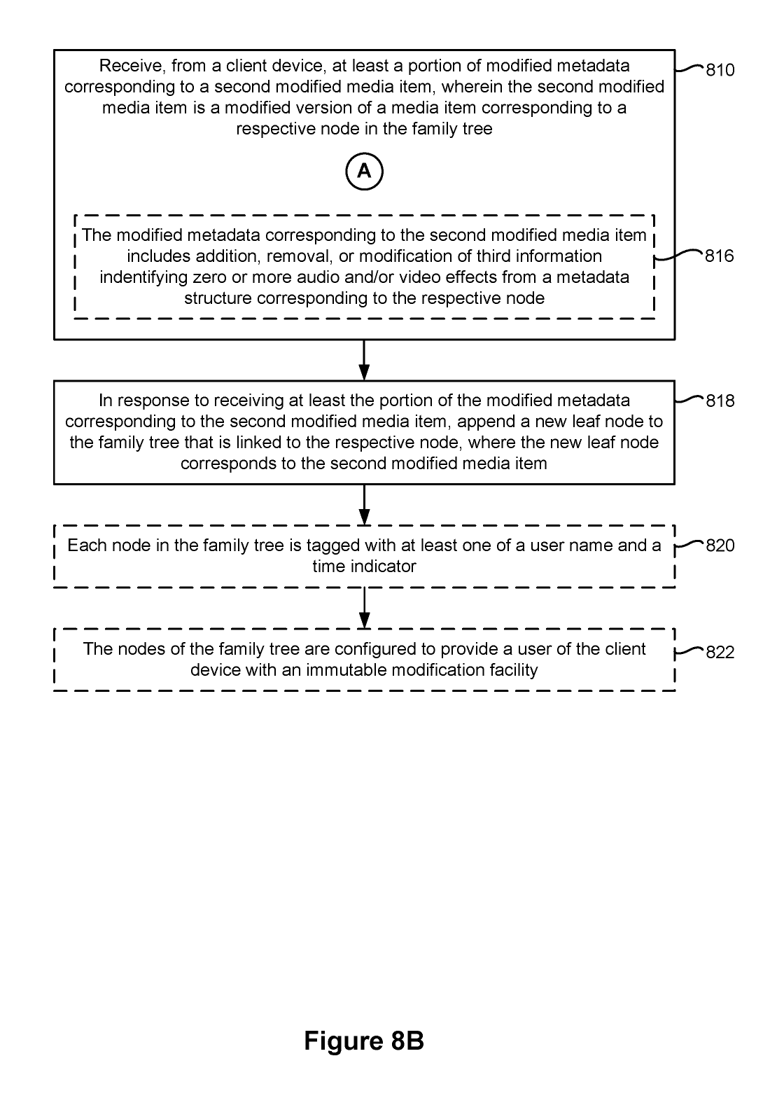

FIGS. 8A-8B illustrate a flowchart diagram of a server-side method 800 of maintaining a database in accordance with some embodiments. In some embodiments, the method 800 is performed by an electronic device with one or more processors and memory. For example, in some embodiments, the method 800 is performed by a server (e.g., the server system 108, FIGS. 1 and 3) or a component thereof (e.g., the server-side module 106, FIGS. 1 and 3). In some embodiments, the method 800 is governed by instructions that are stored in a non-transitory computer readable storage medium and the instructions are executed by one or more processors of the electronic device. Optional operations are indicated by dashed lines (e.g., boxes with dashed-line borders).

The server maintains (802) a database for a plurality of root media items. In some embodiments, a server system 108 or a component thereof (e.g., the maintaining module 320, FIG. 3) maintains a media item metadata database 116 for a plurality of root media items. In some embodiments, the media item metadata database 116 stores a metadata structure for each media item generated by a user in the community of users of the application. In FIG. 5A, for example, each of the metadata regions 502 correspond to a root media item and include metadata structures for the root media item and modified versions of the root media item that comprise a family tree of the root media item.

A respective root media item is associated with (804) a family tree that includes a genesis node and a plurality of leaf nodes. For example, the family tree 468, in FIG. 4I, includes a genesis node 470-a, which corresponds to the root media item, and a plurality of leaf nodes 470-b, 470-c, 470-d, 470-e, 470-f, 470-g, 470-h, 470-i, 470-j, 470-k, and 470-l. In some embodiments, the root media item is a professionally created video (e.g., a music video, film clip, or advertisement) either in “flat” format or in the metadata-annotated format with media items and metadata.

The genesis node corresponds to (806) the respective root media item and a respective leaf node of the plurality of leaf nodes corresponds to a first modified media item, where the first modified media item is a modified version of the respective root media item. In FIG. 4I, for example, the genesis node 470-a corresponds to a root media item (i.e., the original media item) for a family tree 468 and leaf nodes 470-b, 470-c, 470-d, 470-e, 470-f, 470-g, 470-h, 470-i, 470-j, 470-k, 470-l, and 470-m correspond to media items that are modified versions of the root media item.

The genesis node corresponding to the respective root media item and the respective leaf node corresponding to the first modified media item include (808) metadata structures, where a respective metadata structure includes first information identifying one or more audio tracks, second information identifying one or more media files, and third information identifying zero or more audio and/or video effects. For example, the metadata region 502-a of the media item metadata database 116, in FIG. 5A, corresponds to a family tree 468, and metadata structures 504-a . . . 504-m correspond to nodes 470-a . . . 470-m of the family tree 468 in FIG. 51. In this example, the family tree associated with the metadata region 502-a is the family tree 468 in FIG. 4I, and the node corresponding to the metadata structure 504-b is the node 470-b. Continuing with this example, the metadata structure 510, in FIG. 5B, corresponds to the metadata structure 504-b in FIG. 5A, and the metadata structure 510 includes one or more audio track pointer fields 520 for each of the one or more audio tracks associated with the media item, one or more media file pointer fields 520 for each of the one or more media files associated with the media item, and an effects table 522 with entries 523 for each of zero or more audio and/or video effects to be applied to the respective media item at run-time.

The server receives (810), from a client device, at least a portion of a modified metadata corresponding to a second modified media item, where the second modified media item is a modified version of a media item corresponding to a respective node in the family tree (e.g., adding or removing audio/video, or adding, removing, or modifying audio and/or video effects associated with the respective node). For example, a server system 108 or a component thereof (e.g., the receiving module 314, FIG. 3) receives at least a portion of modified metadata associated with a new media item created in response to the client device 104 detecting the one or more second user inputs (e.g., including contact 490 in FIG. 4G) modifying one or more parameters associated with an effect 480-a of the media item corresponding to a node 470-g. In this example, the portion of the modified metadata includes first information identifying the one or more audio tracks associated with the new media item (e.g., an audio track 488-a), second information identifying one or more media files associated with the new media item (e.g., a video clip 484-a), and third information identifying the one or more audio and/or video effects of associated with the new media item (e.g., a modified effect 480-a and another effect 480-b).

In some embodiments, the modified metadata corresponding to the second modified media item includes (812) addition or removal of first information identifying one or more audio tracks from a metadata structure corresponding to the respective node. In some embodiments, the first information in the modified metadata associated with the new media item includes additional audio tracks or ceases to include audio tracks in comparison to the first information in the metadata structure associated with the media item that corresponds to the respective node (e.g., the node 470-g in FIG. 4G).

In some embodiments, the modified metadata corresponding to the second modified media item includes (814) addition or removal of second information identifying one or more media files from a metadata corresponding to the respective node. In some embodiments, the second information in the modified metadata structure associated with the new media item includes additional video clips or ceases to include video clips in comparison to the second information in the metadata structure associated with the media item that corresponds to the respective node (e.g., the node 470-g in FIG. 4G).

In some embodiments, the modified metadata corresponding to the second modified media item includes (816) addition, removal, or modification of third information identifying zero or more audio and/or video effects from a metadata structure corresponding to the respective node. In some embodiments, the third information in the modified metadata associated with the new media item includes additional audio and/or video effects, ceases to include audio and/or video effects, or includes modified audio and/or video effects in comparison to the third information in the metadata structure associated with the media item that corresponds to the respective node (e.g., the node 470-g in FIG. 4G).

In response to receiving at least the portion of the modified metadata corresponding to the second modified media item, appends (818), to the family tree, a new leaf node that is linked to the respective node, where the new leaf node corresponds to the second modified media item. For example, in response to receiving the portion of the modified metadata, a server system 108 or a component thereof (e.g., the generating module 324, FIG. 3) generates a metadata structure for the new media item and appends a new node associated with the new media item to a corresponding family tree. For example, a node 470-m corresponding to the new media item is appended to the family tree 468 as shown in FIG. 4I, and a metadata structure 504-m corresponding to the new media item is added to the metadata region 502-a in FIG. 5A.

In some embodiments, each node in the family tree is tagged (820) with at least one of a user name and a time indicator (e.g., a date/time stamp). For example, the metadata structure 510, in FIG. 5B, corresponds to the metadata structure 504-b in FIG. 5A and includes an author field 514 with the identifier, name, or handle associated with the creator/author of the metadata structure 510 and a date/time field 516 with a date and/or time stamp associated with generation of the metadata structure 510.

In some embodiments, each media item and metadata field in the metadata structure corresponding to the media item is tagged with at least one of a user name and a time indicator. In this way, an attribution history may be stored and displayed to users for the purposes of entertainment, community building, copyright attribution, monetization, advertising, or other reasons. For example, user A added a first effect to a media item and during a subsequent modification of the media item, user B added a second effect to the media item. In this example, with respect to the modified media item, the first effect is attributed to user A and the second effect is attributed to user B. Continuing with this example, in some embodiments, user A and user B share in the advertising revenue generated from users watching the modified media item.

In some embodiments, the nodes of the family tree are configured to provide (822) a user of the client device with an immutable modification facility. For example, a new node may be generated from any of the nodes in the family without modifying the pre-existing nodes in the family tree. In this way, the family tree forms an immutable graph of modifications to the root media item. For example, a user may start at a leaf node in a family tree and undo modifications until the user is back to the genesis node in the family tree.

In some embodiments, owners of copyrighted audio tracks and video clips upload at least a sample of the audio tracks and video clips to reference database 344 (FIG. 3) associated with the provider of the application. In some embodiments, when the server appends the new leaf node to the family tree, a server system 108 or a component thereof (e.g., the analyzing module 326, FIG. 3) analyzes the one or more audio tracks and one or more video clips associated with the respective media item to determine a digital fingerprint for the audio tracks and video clips. In some embodiments, when the server system 108 or a component thereof (e.g., the determining module 328, FIG. 3) determines that the digital fingerprint for the audio tracks and video clips associated with the respective media item matches copyrighted audio tracks and/or video clips in a reference database 344, the server system 108 or a component thereof is configured to further link the new node to a node or family tree associated with the copyrighted audio tracks and/or video clips.

### Generating Audiovisual Media Items at a Server

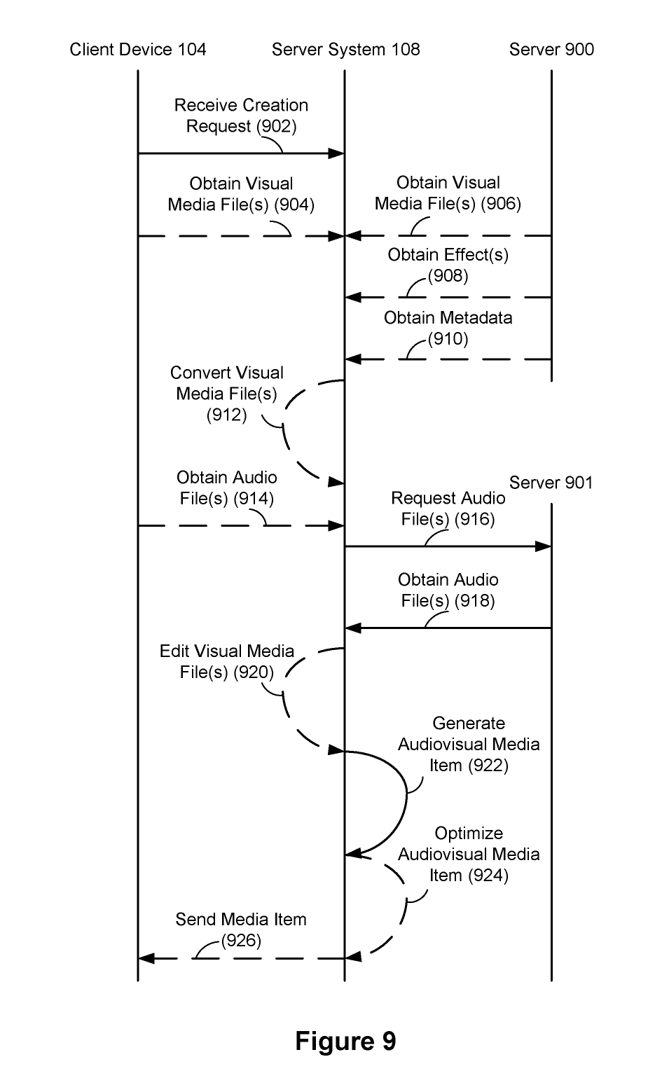

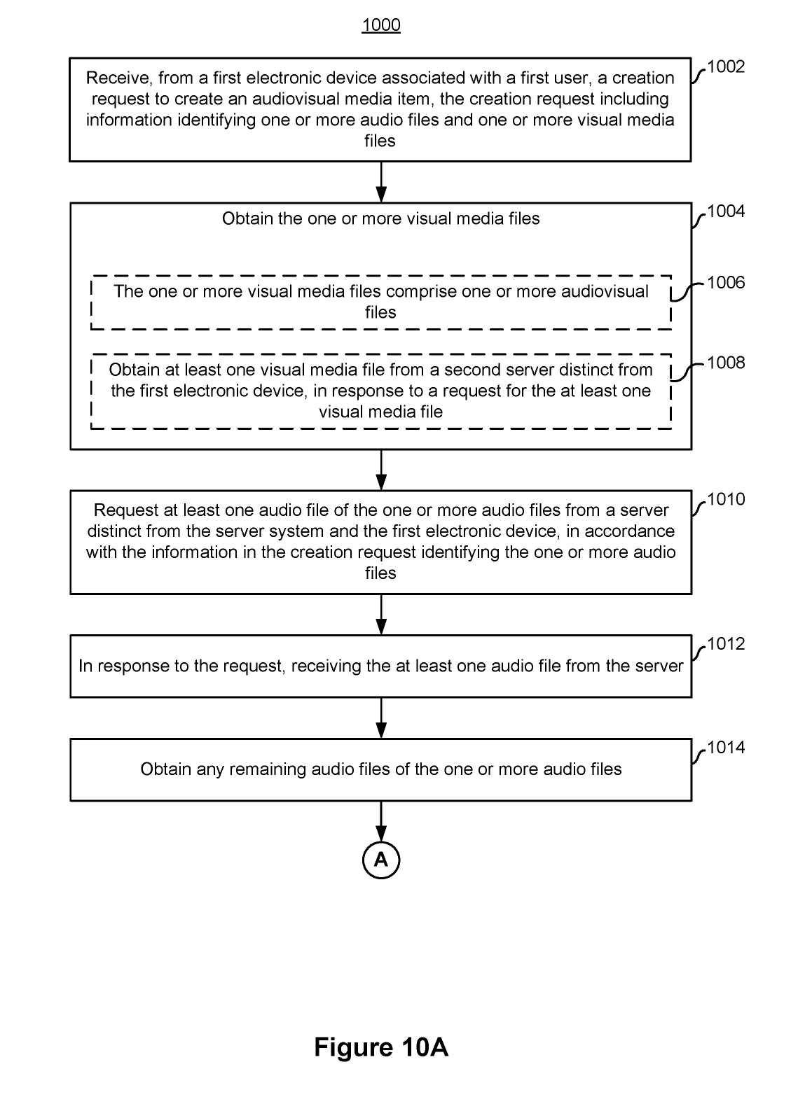

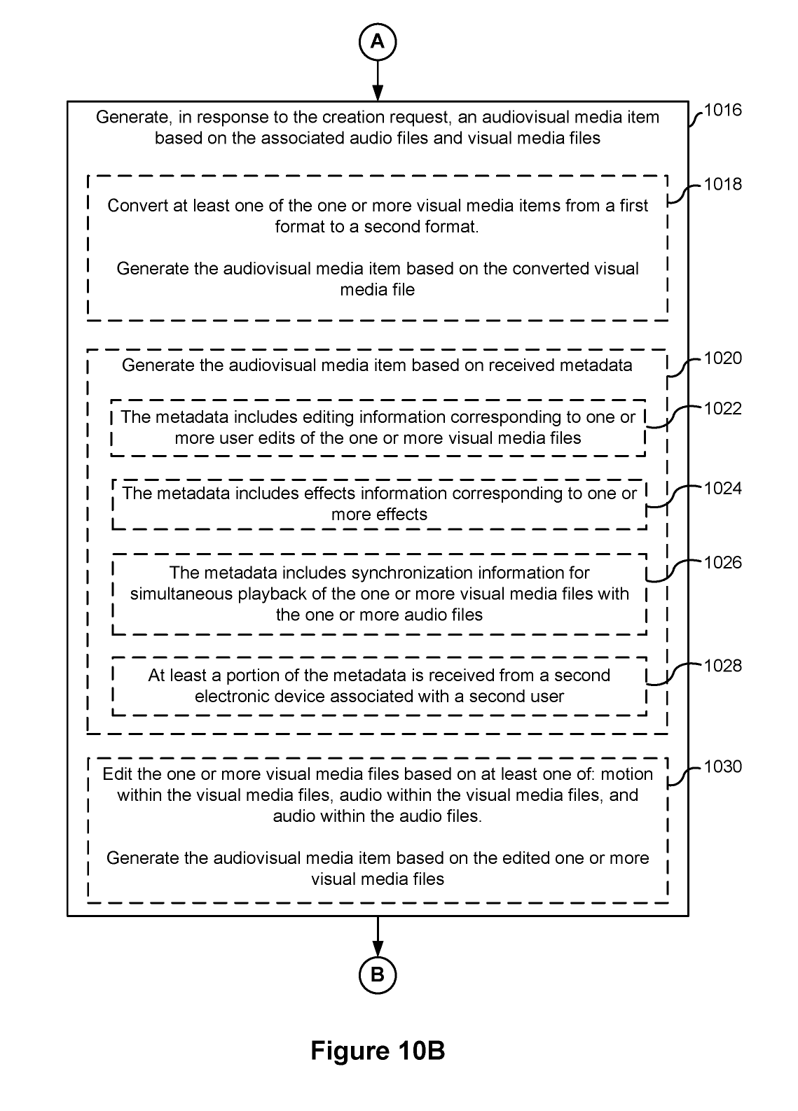

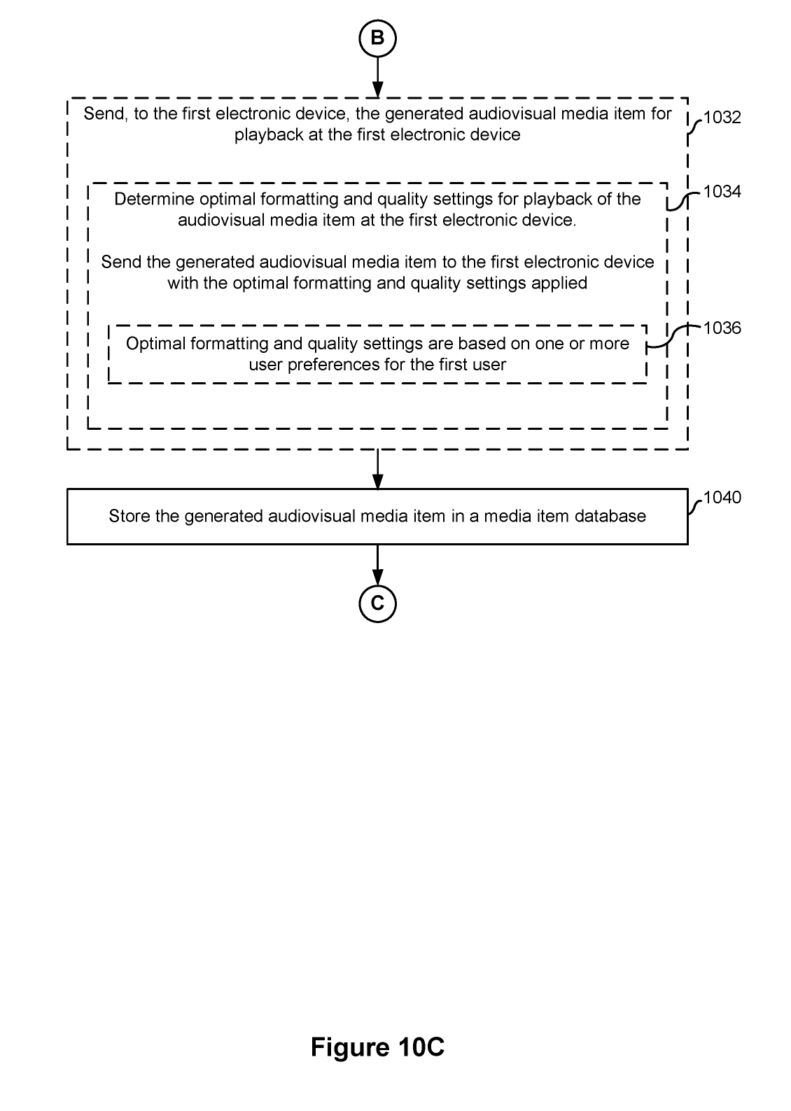

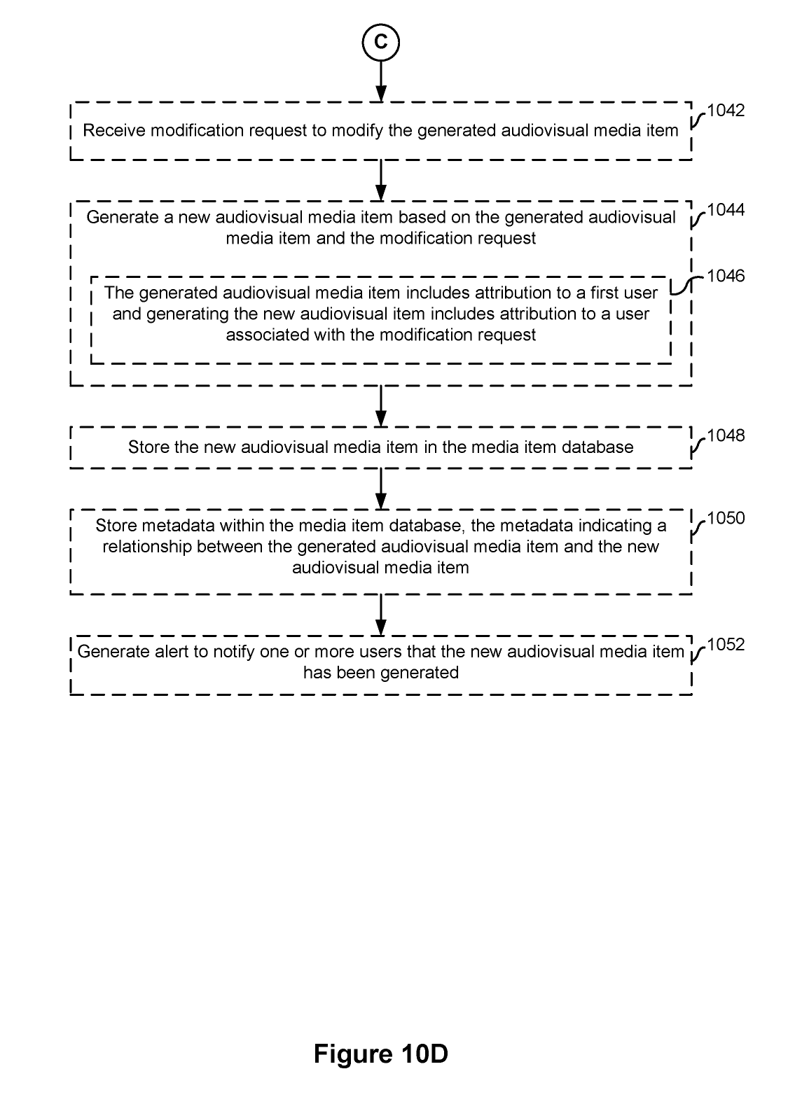

FIG. 9 is a schematic flow diagram of a method for generating audiovisual media items at a server system (e.g. the server system 108, FIGS. 1 and 3), in accordance with some embodiments. The flow diagram in FIG. 9 is used to illustrate methods described herein, including the method described with respect to FIGS. 10A-10D. The server system 108 receives (902) a creation request, including information identifying one or more audio files and one or more visual media files, from a client device (e.g., the client device 104, FIGS. 1-2) associated with a first user (e.g., the client device 104, an app thereon, a module, or the like, is registered to the first user). In some embodiments the server system 108 can be a module (e.g., the server-side module 106 in FIGS. 1 and 3). In some embodiments the client device 104 can be a module (e.g., the client-side module 102 in FIGS. 1 and 2).

The server system 108 in FIG. 9 obtains (904) (e.g., receives or generates) one or more: visual media files from a client device 104; visual media files (906) from a server 900 distinct from the server system 108 and the client device 104 (e.g., external services such as audio sources 124a . . . 124n or media file sources 126a . . . 126n discussed above with respect to FIG. 1); effects (908) from a server 900; and metadata (910) from a server 900. In some embodiments the server system 108 then converts (912) the visual media files (e.g., visual media files formatted in one type of formatting such as MPEG, GIF, GPP, QuickTime, Flash Video, Windows Media Video, RealMedia, Nullsoft Streaming Video, and the like, are converted to another formatting type).

In some embodiments the server system 108 obtains (914) one or more audio files from the client device 104. The server system 108 requests (916) one or more audio files from a server 901 (e.g., a server distinct from the server system and the client device 104). In response to the request for audio files (916), the server system 108 obtains (916) the one or more audio files from the server 901. In some embodiments the server system 108 edits (920) the visual media files according to edit information contained in the metadata obtained (e.g., in some embodiments edit information corresponds to edits of the audio files, the synchronization information, or the effects, etc., as discussed in greater detail above with respect to FIGS. 5A and 5B). The server system 108 generates (922) an audiovisual media item based on the one or more audio files and the one or more visual media files, and stores the generated audiovisual media item in a media file database (e.g., the media files database 114 in FIG. 3).

In some embodiments the server system 108 optimizes (924) the audiovisual media item (e.g., determines optimal formatting and quality settings for playback of the audiovisual media item at the first electronic device based on the client device 104 operating system, hardware capabilities, connection type, user specified settings, etc.). In some embodiments the server system sends (926) the audiovisual media item for playback at the client device 104.

FIGS. 10A-10D illustrate a flowchart diagram of a server-side method 1000 of generating a media item in accordance with some embodiments. In some embodiments, the method 1000 is performed at a server system with one or more processors and memory. For example, in some embodiments, the method 1000 is performed at a server system 108 (e.g., server system 108, FIGS. 1 and 3) or a component thereof (e.g., server-side module 106, FIGS. 1 and 3). In some embodiments, method 1000 is governed by instructions that are stored in a non-transitory computer readable storage medium and the instructions are executed by one or more processors of the server system 108. Optional operations are indicated by dashed lines (e.g., boxes with dashed-line borders).

A server system 108 receives (1002) a creation request (e.g., receive creation request 902, discussed above with reference to FIG. 9), from a first electronic device (e.g. the client device 104, FIGS. 1 and 2) associated with a first user (e.g., the client device 104, an app thereon, a module, or the like, is registered to the first user). In some embodiments the creation request 902 is received by a module (e.g., receiving module 314, FIG. 3, described in greater detail above). In some embodiments the creation request 902 is from a requesting module (e.g., requesting module 226, FIG. 2, described in greater detail above). The creation request 902 includes information identifying one or more audio files and one or more visual media files. The server system 108 obtains (1004) the one or more visual media files. In some embodiments the server system 108 generates the one or more visual media files with a generating module (e.g., generating module 324, FIG. 3, described in greater detail above).

In some embodiments the one or more visual media files comprise one or more audiovisual files (1006). In some embodiments the server system 108 obtains (1008) at least one visual media file from a first server (e.g., server 900, discussed above with reference to FIG. 9) distinct from the server system 108 and the client device 104. As an example, the first server 900 is a service provider of images and/or video such as YouTube, Vimeo, Vine, Flickr, Imgur, and the like.

In accordance with the information identifying the one or more audio files in the creation request 902, the server system 108 requests (1010) the at least one audio file from a server (e.g., the server 901, discussed above with reference to FIG. 9, which is distinct from the server 900) distinct from the server system 108 and the client device 104. In response to the request (1010), the server system 108 receives (1012) the at least one audio file from the server. The server system obtains (1014) any remaining audio files of the one or more audio files.

Referring now to FIG. 10B, the server system generates (1016) an audiovisual media item based on the associated audio files and visual media files of the creation request 902. In some embodiments the server system converts at least one of the one or more visual media files from a first format to a second (e.g., converting visual media files (912) in FIG. 9, discussed in greater detail above) and generates (1018) the audiovisual media item based on the converted file. In some embodiments the server system 108 generates (1020) the audiovisual item based on received metadata (e.g., the media file pointer(s) 518, the audio track pointer(s) 520, the audio start time(s) 521, and the like in FIG. 5B, discussed in greater detail above).

In some embodiments the metadata includes: editing information (1022) corresponding to one or more user edits (e.g., edit information corresponds to at least one of: edits of the audio files, edits of the synchronization information, edits of the effects, and the family tree of the root media item, as discussed in greater detail above with respect to FIGS. 5A-5B, 8A-8B, and 9); effects information (1024) corresponding to one or more effects (e.g., the effects table 522, and the interactive effects table 524, FIG. 5B, discussed in greater detail above); and synchronization information (1026) for simultaneous playback of the one or more visual media files with the one or more audio files (e.g., media file pointer(s) 518, audio track pointer(s) 520, audio start time(s) 521, and the like in FIG. 5B, discussed in greater detail above).

In some embodiments at least a portion of the metadata received is received (1030) from a second electronic device associated with a second user (e.g., the client device 104-2 or the client-side module 102-2 in FIG. 1, an app thereon, or the like, is registered to a second user). In some embodiments the server system 108 edits (1030) the one or more visual media files based on at least one of: motion within the visual media files, audio within the visual media files (e.g., music, dialogue, or background sounds), and audio within the audio files, the server system 108 then generates the audiovisual media item based on the edited one or more visual media files.

Turning to FIG. 10C, method 1000, in some embodiments, sends (1032), to the client device 104, the generated audiovisual media item for playback at the client device 104. In some embodiments the server system 108 determines (1034) optimal formatting and quality settings for playback at the client device 104 and sends the generated audiovisual media item to the client device 104 with the optimal formatting and quality settings applied (e.g., optimizing (924) audiovisual media item in FIG. 9, discussed in greater detail above). In some embodiments optimal formatting and quality settings are based (1036) on one or more user preferences for the first user (e.g., the user profile 264 in FIG. 2 includes user defined settings for formatting and quality). In some embodiments the server system 108 stores (1040) the generated audiovisual media item in a media item database (e.g., the media files database 114 of FIGS. 1 and 3, discussed in greater detail above).

Referring now to FIG. 10D, in some embodiments of method 1000, the server system 108 receives (1042) a modification request to modify the generated audiovisual media. For example, a creation request (902), discussed in further detail above with respect to FIG. 9, identifies the generated audiovisual media item. In some embodiments the server system 108 generates (1044) a new audiovisual media item based on the generated audiovisual media item and the modification request. In some embodiments the generated audiovisual media item includes (1046) attribution to a first user and the generation of a new audiovisual item includes attribution to a user association with the modification request (e.g., metadata associated with the audiovisual media item can include an author 514, described in further detail above with respect to FIGS. 5A-5B).

In some embodiments the method 1000 further includes storing (1048) the new audiovisual media item in the media item database (e.g., the media files database 114 of FIGS. 1 and 3, discussed in greater detail above). In some embodiments the method 1000 stores (1050) metadata within the media item database, the metadata indicating a relationship between the generated audiovisual media item and the new audiovisual media item (e.g., the metadata can include family tree information as discussed above with reference to FIGS. 4A-4I). The method 1000, in some embodiments, can also include generating (1052) an alert to notify one or more users that the new audiovisual media item has been generated.

### Natural Language Processing of User Inputs

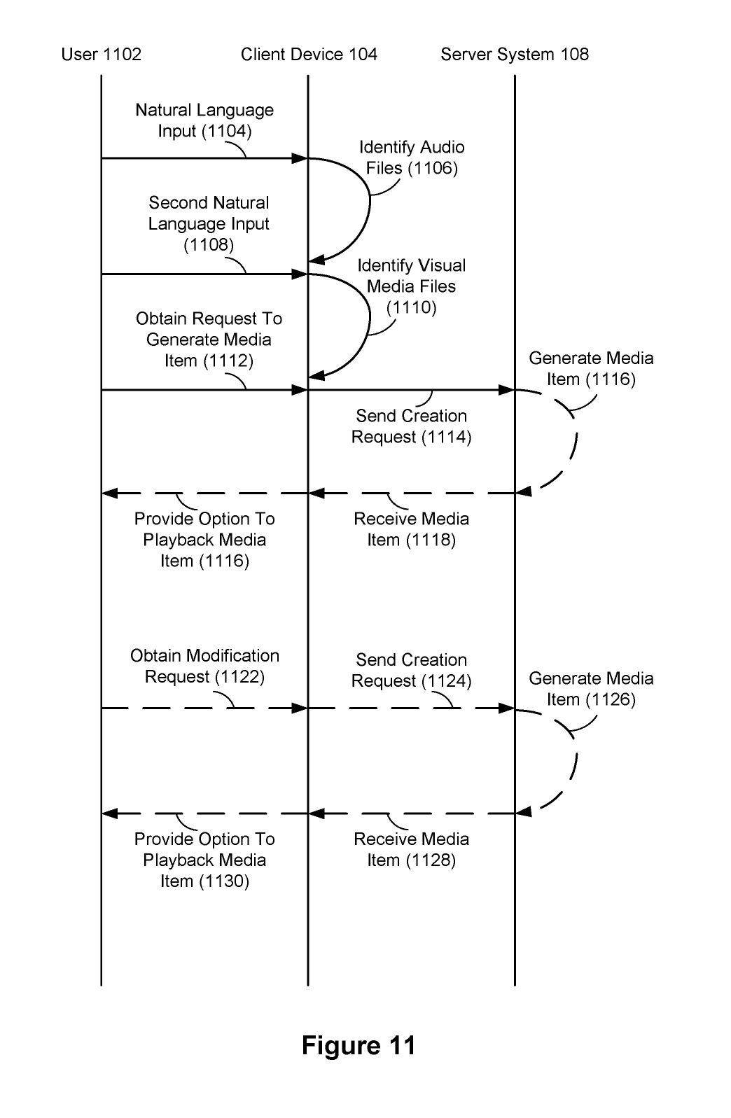

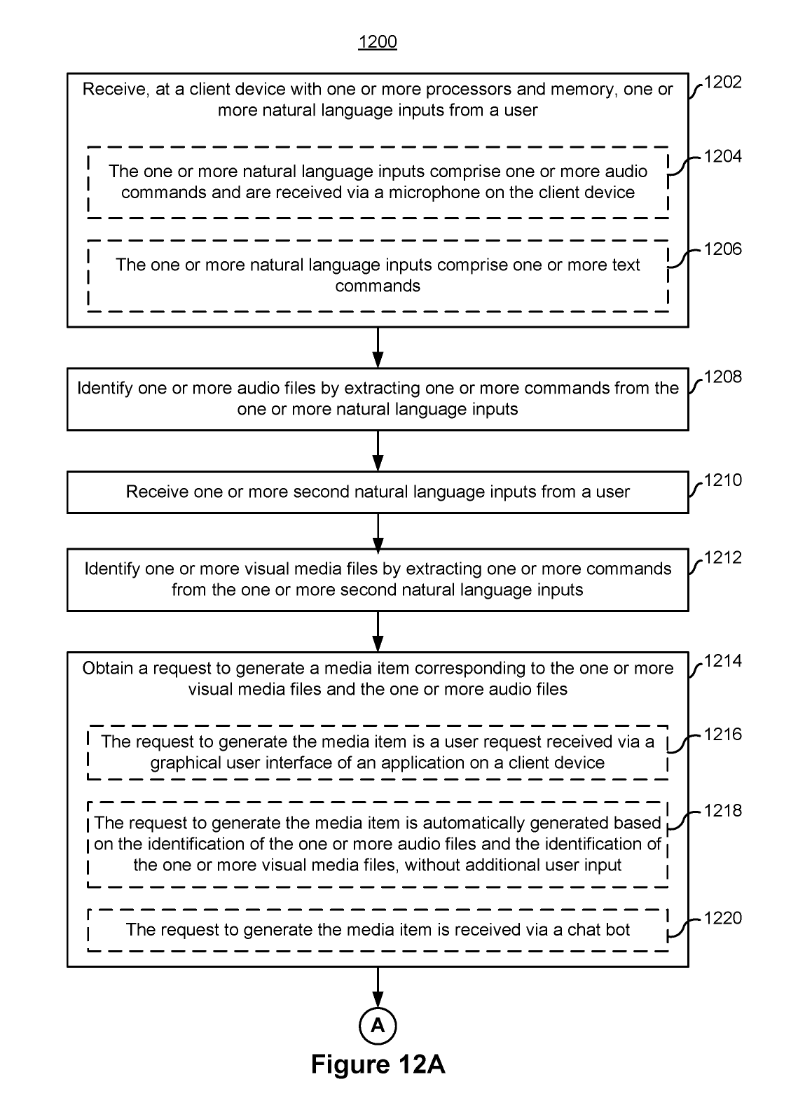

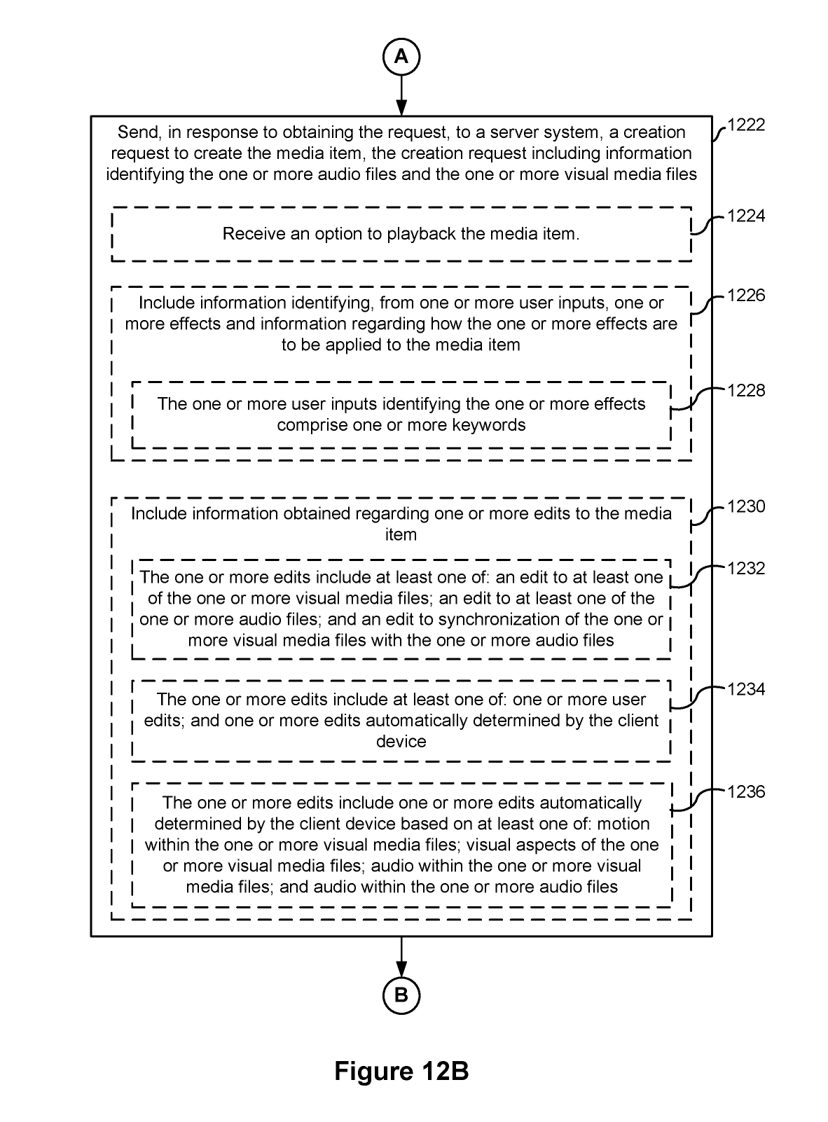

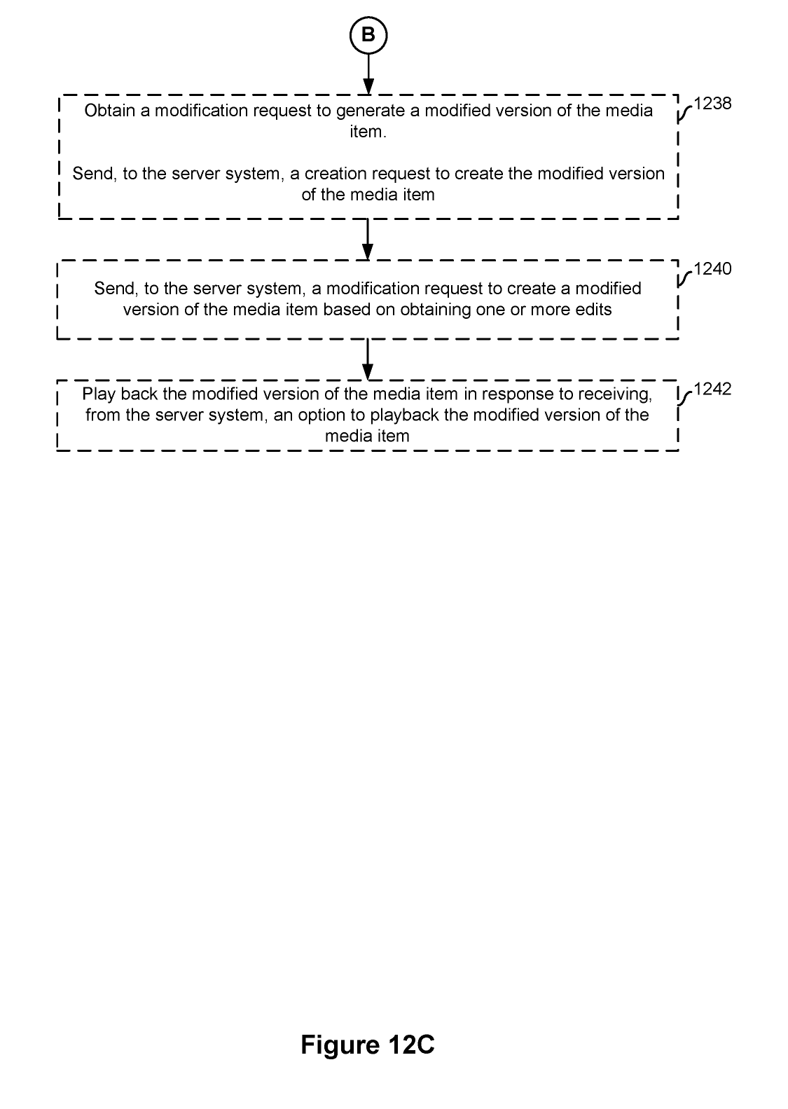

FIG. 11 is a schematic flow diagram of a method for receiving natural language inputs at a client device (e.g., the client device 104, FIGS. 1-2), in accordance with some embodiments. The flow diagram in FIG. 11 is used to illustrate methods described herein, including the method described with respect to FIGS. 12A-12C. The client device 104 receives (1104) a natural language input. For example, the user device 104 receives (e.g., via the receiving module 228, discussed above with reference to FIG. 2) a stream (e.g., stream 122, discussed above with reference to FIG. 1) that includes audio, text, or other data in the form of natural language (e.g., conversational language, plain language, hand signals, ordinary language, and the like). The source of the natural

The client device 104 identifies (1106) one or more audio files by extracting one or more commands from the natural language input (e.g., by processing input with an input processing module 222, discussed above with reference to FIG. 2). In some embodiments the natural language input is detected (e.g., by detecting module 224, discussed above in reference to FIG. 2) by the client device 104 (e.g., at a touch sensitive surface, a microphone, a camera, an antenna, a transceiver, a USB cable, or similar electronic component capable of input detection). In some embodiments the identification of the one or more audio files is not explicit. For example, the identification comprises one or more search parameters (such as “the most popular song by artist X”) and requires the client device 104 or a server system (e.g., the server system 108, discussed in detail above with reference to FIGS. 1 and 3) perform a search to identify the specific files. In some embodiments the natural language input can be streams, such as streams 122a . . . 122n described above with respect to FIG. 1.

The client device 104 receives (1108) one or more second natural language inputs from a user (e.g., as described above with respect to the schematic flow operation 1104). The client device 104 identifies (1110) visual media files by extracting one or more commands from the one or more second natural language inputs (e.g., as discussed above with respect to schematic flow operation 1106). In some embodiments the client device 104 obtains (1112) a request to generate a media item corresponding to the one or more visual media files and the one or more audio files. In response to the obtained request, the client device 104 sends (1114) a creation request to a server system (e.g., the server system 108 discussed above in further detail with respect to FIGS. 1 and 3), the creation request including information identifying the one or more audio files and the one or more visual media files. The server system 108 can generate (1116) a media item based on the creation request sent (1114). For example, the server system 108 generates audiovisual items at the server system 108 as described above with respect to FIGS. 9, and 10A-10D.

In some embodiments the client device 104 receives (1118) a media item from the server system 108 (e.g., the audiovisual item generated by the creation request, or another media item or file). In some embodiments the client device 104 provides (1120) an option to playback the received media item (e.g., the audiovisual media item requested to be generated based on the natural language inputs, a media item received (1118) from the server system 108, and the like is presented by presenting module 234, described in further detail above with respect to FIG. 2). In some embodiments the client device 104 obtains (1122) a modification request (e.g., by detecting module 224, described in further detail above with respect to FIG. 2) to generate a modified version of the media item. In some embodiments the client device 104 sends (1124) a creation request to the server system 108 to create the modified version of the media item. In some embodiments, the server system 108 can generate a media item based on the creation request sent (1124) by the client device 104 (e.g., the server system 108 generates audiovisual items at the server system 108 as described above with respect to FIGS. 9, and 10A-10D). In some embodiments the client device 104 receives (1128) the generated media item. In some embodiments, the client device 104 further provides (1130) an option to playback the media item.

FIGS. 12A-12C illustrate a flowchart diagram of a client-side method 1200 of generating a media item in accordance with some embodiments. In some embodiments, the method 1200 is performed at a client device with one or more processors and memory. For example, in some embodiments, the method 1200 is performed at a client device 104 (e.g., client device 104, FIGS. 1 and 2) or a component thereof (e.g., client-side module 102, FIGS. 1 and 2). In some embodiments, method 1200 is governed by instructions that are stored in a non-transitory computer readable storage medium and the instructions are executed by one or more processors of the client device 104. Optional operations are indicated by dashed lines (e.g., boxes with dashed-line borders).

A client device 104 receives (1202) one or more natural language inputs from a user (e.g., receive natural language input (1104), discussed above in reference to FIG. 11). In some embodiments the one or more natural language inputs comprise (1204) one or more audio commands and are received via a microphone on the client device 104 (e.g., input device 214, discussed above with reference to FIG. 2). In some embodiments the one or more natural language inputs comprise (1206) one or more text commands. For example, the text commands are received via SMS.

Method 1200, in some embodiments, identifies (1208) one or more audio files by extracting one or more commands from the one or more natural language inputs (e.g., identify audio files (1106) described above with reference to FIG. 11). The client device 104 receives (1210) one or more second natural language inputs from a user (e.g., receive natural language input (1104), discussed above in reference to FIG. 11). For example, the one or more second natural language commands can be audio commands received via a microphone, text commands detected by the user, gestures detected by a camera, text commands received by SMS, and the like. In some embodiments the client device identifies (1212) one or more visual media files by extracting one or more commands from the one or more second natural language inputs (e.g., as described above with respect to operation 1208).

In some embodiments, method 1200 obtains (1214) a request to generate a media item corresponding to the one or more visual media items and the one or more audio files. For example, a user wishes to combine one or more of: audio from one or more audio files, video from one or more video files, audio and visual media from audiovisual media files. In some embodiments the request to generate the media item is received (1216) via a graphical user interface of an application on a client device 104 (e.g., the graphical user interface described above in reference to FIGS. 4A-4I, or other similar interface). In some embodiments the request to generate the media item is automatically (1218) generated based on the identification of the one or more audio files and the identification of the one or more visual media files, without additional user input. In some embodiments the request to generate the media item is received (1220) via chatbot (e.g., a Twitter bot, an instant messenger bot, and the like).

Turning now to FIG. 12B, in some embodiments the method 1200, in response to obtaining the request, sends (1222) a creation request to create the media item to a server system (e.g., the server system 108, FIGS. 1 and 3), the creation request including information identifying the one or more audio files and the one or more visual media files. In some embodiments the client device 104 receives (1224) an option to playback the created media item. In some embodiments the creation request includes (1226) information identifying, from one or more user inputs, one or more effects and information regarding how the one or more effects are to be applied to the media item. For example, audio or visual effects as discussed in further detail above with respect to FIG. 4G. In some embodiments the one or more user inputs identifying the one or more effects include (1228) one or more keywords (e.g., specific hashtags such as #effect1).

In some embodiments, the creation request includes (1230) information obtained regarding one or more edits to the media item. In some embodiments the one or more edits include (1234) at least one of: an edit to at least one of the one or more visual media files; an edit to at least one of the one or more audio files; and an edit to synchronization of the one or more visual media files with the one or more audio files (e.g., edit information as discussed in greater detail above with respect to FIGS. 5A and 5B, an edit to synchronize the visual media files with a second audio track rather than a first audio track, and the like). In some embodiments the edit information can include at least one of: one or more user edits; and one or more edits automatically determined by the client device For example one user of a client device inputs one or more edits and a second user or the client device add one or more further edits which are collectively included in the creation request. Another example is that an existing audiovisual media item that includes edit information is identified and further edits are added by the client device 104, a creation request then includes both the existing edit information as well as the new edits. In some embodiments the one or more edits include (1236) one or more edits automatically determined by the client device based on at least one of: motion within the one or more visual media files; visual aspects of the one or more visual media files (e.g., video brightness, contrast, etc.); audio within the one or more visual media files (such as music, dialogue, or background sounds); and audio within the one or more audio files.

Attention is now directed to FIG. 12C. Method 1200, in some embodiments, in response to obtaining a modification request to generate a modified version of the media item, sends (1238) a creation request to create the modified version of the media item to the server system 108. For example, in some embodiments the modification request is triggered by the user identifying at least one of: a new audio file, and a new video file. In some embodiments the client device 104 sends (1240), to the server system 108, a modification request to create a modified version of the media item based on obtaining one or more edits. In some embodiments, the edits include edits to at least one of: the visual media files, the synchronization of the audio and video files, and the like. In some embodiments, the modification request is sent without receiving any additional user input. In some embodiments the client device 104 plays back (1242) the modified version of the media item in response to receiving, from the server system 108, an option to playback the modified version of the media item.

It will be understood that, although the terms “first,” “second,” etc. may be used herein to describe various elements, these elements should not be limited by these terms. These terms are only used to distinguish one element from another. For example, a first user input could be termed a second user input, and, similarly, a second user input could be termed a first user input, without changing the meaning of the description, so long as all occurrences of the “first user input” are renamed consistently and all occurrences of the “second user input” are renamed consistently. The first user input and the second user input are both user inputs, but they are not the same user input.

The terminology used herein is for the purpose of describing particular embodiments only and is not intended to be limiting of the claims. As used in the description of the embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method for generating an audiovisual media item, the method comprising:
at a server system with one or more processors and memory:
receiving, from a first electronic device associated with a first user, a creation request to create the audiovisual media item, the creation request including information identifying one or more audio files and one or more visual media files;
obtaining the one or more visual media files;
requesting at least one audio file of the one or more audio files from a server in accordance with the information in the creation request identifying the one or more audio files, the server distinct from the server system and the first electronic device;
in response to the request, receiving the at least one audio file from the server;
obtaining any remaining audio files of the one or more audio files;
in response to receiving the creation request, generating the audiovisual media item based on the one or more audio files and the one or more visual media files; and
storing the generated audiovisual media item in a media item database.

2. The method of claim 1, wherein the one or more visual media files comprise one or more audiovisual files.

3. The method of claim 1, wherein generating the audiovisual media item comprises:
converting at least one of the one or more visual media files from a first format to a second format; and
generating the audiovisual media item based on the converted visual media file.

4. The method of claim 1, wherein at least one of the one or more visual media files is obtained from a second server, distinct from the server system and the first electronic device; and
the method further comprises requesting the at least one visual media file from the second server in accordance with the information in the creation request identifying the one or more visual media files.

5. The method of claim 1, further comprising receiving metadata associated with the one or more visual media files; and
wherein generating the audiovisual media item comprises generating the audiovisual media item based on the one or more audio files, the one or more visual media files, and the received metadata.

6. The method of claim 5, wherein the metadata includes editing information, the editing information corresponding to one or more user edits of the one or more visual media files; and
wherein generating the audiovisual media item comprises editing at least one of the one or more visual media files based on the editing information.

7. The method of claim 5, the method further comprising obtaining one or more effects; and
wherein the metadata includes effects information, the effects information corresponding to one or more effects.

8. The method of claim 5, wherein the metadata includes synchronization information for simultaneous playback of the one or more visual media files with the one or more audio files.

9. The method of claim 5, wherein at least a portion of the metadata is received from a second electronic device, the second electronic device associated with a second user.

10. The method of claim 1, wherein generating the audiovisual media item further comprises editing the one or more visual media files; and
wherein editing the one or more visual media files includes editing the one or more visual media files based on at least one of:
motion within the one or more visual media files;
audio within the one or more visual media files; and
audio within the one or more audio files.

11. The method of claim 1, further comprising sending, to the first electronic device, the generated audiovisual media item for playback at the first electronic device.

12. The method of claim 11, further comprising determining optimal formatting and quality settings for playback of the audiovisual media item at the first electronic device; and
wherein sending the generated audiovisual media item to the first electronic device comprises sending the generated audiovisual media item with the optimal formatting and quality settings applied.

13. The method of claim 12, wherein the optimal formatting and quality settings are based on one or more user preferences of the first user.

14. The method of claim 1, further comprising:
receiving a modification request to modify the generated audiovisual media item;
generating a new audiovisual media item based on the generated audiovisual media item and the modification request;
storing the new audiovisual media item in the media item database; and
storing metadata within the media item database, the metadata indicating a relationship between the generated audiovisual media item and the new audiovisual media item.

15. The method of claim 14, wherein the modification request is associated with a second user;
wherein generating the audiovisual media item includes attributing the audiovisual media item to the first user; and
wherein generating the new audiovisual media item includes attributing the new audiovisual media item to the second user.

16. The method of claim 14, further comprising generating an alert to notify one or more users that the new audiovisual media item has been generated.

17. A server system comprising:
one or more processors; and
memory coupled to the one or more processors, the memory storing one or more programs configured to be executed by the one or more processors, the one or more programs comprising instructions for:
receiving, from a first electronic device associated with a first user, a creation request to create the audiovisual media item, the creation request including information identifying one or more audio files and one or more visual media files;
obtaining the one or more visual media files;
requesting at least one audio file of the one or more audio files from a server in accordance with the information in the creation request identifying the one or more audio files, the server distinct from the server system and the first electronic device;
in response to the request, receiving the at least one audio file from the server;
obtaining any remaining audio files of the one or more audio files;
in response to receiving the creation request, generating the audiovisual media item based on the one or more audio files and the one or more visual media files; and
storing the generated audiovisual media item in a media item database.

18. The server system of claim 17, the one or more programs further comprising instructions for receiving metadata associated with the one or more visual media files; and
wherein generating the audiovisual media item comprises generating the audiovisual media item based on the one or more audio files, the one or more visual media files, and the received metadata.

19. A non-transitory computer-readable storage medium storing one or more programs, the one or more programs comprising instructions, which when executed by a server system, cause the system to:
receive, from a first electronic device associated with a first user, a creation request to create the audiovisual media item, the creation request including information identifying one or more audio files and one or more visual media files;
obtain the one or more visual media files;
request at least one audio file of the one or more audio files from a server in accordance with the information in the creation request identifying the one or more audio files, the server distinct from the server system and the first electronic device;
in response to the request, receive the at least one audio file from the server;
obtain any remaining audio files of the one or more audio files;
in response to receiving the creation request, generate the audiovisual media item based on the one or more audio files and the one or more visual media files; and
store the generated audiovisual media item in a media item database.

20. The storage medium of claim 19, the one or more programs further comprising instructions, which when executed by the server system, cause the system to receive metadata associated with the one or more visual media files; and
wherein generating the audiovisual media item comprises generating the audiovisual media item based on the one or more audio files, the one or more visual media files, and the received metadata.
